(19) United States
(12) Patent Application Publication
(10) Pub. No.: US 2024/0172094 A1
(43) Pub. Date: May 23, 2024

(54) USER EQUIPMENT (UE) HANDLING OF MULTIPLE BROADCASTED TRACKING AREA CODES

(71) Applicant: Telefonaktiebolaget LM Ericsson (publ), Stockholm (SE)

(72) Inventors: Helka-Liina MÄÄTTÄNEN, Espoo (FI); Johan RUNE, Lidingö (SE); Mikael WASS, Sätila (SE); Emre YAVUZ, Stockholm (SE); Stefan ROMMER, Västra Frölunda (SE); Paul SCHLIWA-BERTLING, Ljungsbro (SE)

(21) Appl. No.: 18/283,070

(22) PCT Filed: Mar. 29, 2022
(86) PCT No.: PCT/IB2022/052902

§ 371 Date: Sep. 20, 2023

Related U.S. Application Data
(60) Provisional application No. 63/169,672, filed on Apr. 1, 2021.

(51) Int. Cl. H04W 48/10; H04W 60/04; H04W 84/06

(52) U.S. Cl. CPC H04W 48/10; H04W 60/04; H04W 84/06

(57) ABSTRACT

A method performed by a user equipment, UE, and a UE is provided. The method includes obtaining tracking area codes, TACs, broadcast in a cell of a network. The method includes responsive to none of the broadcast TACs being a last previously selected TAC in the UE, selecting, by a non-access stratum, NAS, layer or an access stratum, AS, layer of the UE, one TAC of the broadcast TACs to be a current TAC of the UE.

### TECHNICAL FIELD

The present disclosure relates generally to communications, and more particularly to communication methods and related devices and nodes supporting wireless communications.

### BACKGROUND

In 3rd Generation Partnership Project (3GPP) release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since 3GPP release 13, NB-IoT (narrowband internet of things) and LTE-M (LTE-MTC (machine type communication)) are part of the LTE specifications and provide connectivity to massive machine type communications (mMTC) services.

In 3GPP release 15, the first release of the 5th Generation (5G) system (5GS) was specified. This is a new generation's radio access technology intended to serve use cases such as evolved mobile broadband (eMBB), ultra-reliable and low latency communication (URLLC) and massive machine-type communications (mMTC). 5G includes the New Radio (NR) access stratum (AS) interface and the 5G Core Network (5GC). The NR physical and higher layers are reusing parts of the LTE specification, and to that add needed components when motivated by the new use cases. One such component is the introduction of a sophisticated framework for beam forming and beam management to extend the support of the 3GPP technologies to a frequency range going beyond 6 GHz.

Satellite Communications

NR Non-Terrestrial Networks

In 3GPP release 15, 3GPP started the work to prepare NR for operation in a Non-Terrestrial Network (NTN). The work was performed within the study item “NR to support Non-Terrestrial Networks” and resulted in TR 38.811. In 3GPP release 16, the work to prepare NR for operation in an NTN network continued with the study item “Solutions for NR to support Non-Terrestrial Network.” Related work on providing the necessary enhancements for the 5G Core Network is also being progressed in 3GPP rel-17, based on a study performed during rel-16 timeframe. In parallel, the interest to adapt NB-IoT and LTE-M for operation in NTN is growing. As a consequence, 3GPP release 17 contains both a work item on NR NTN and a study item on NB-IoT and LTE-M support for NTN.

A satellite radio access network usually includes the following components (see FIG. 1):
1. A satellite that refers to a space-borne platform.
2. An earth-based gateway that connects the satellite to a base station or a core network, depending on the choice of architecture.
3. Feeder link that refers to the link between a gateway and a satellite
4. Access link that refers to the link between a satellite and a user equipment (UE).

Depending on the orbit altitude, a satellite may be categorized as low earth orbit (LEO), medium earth orbit (MEO), or geostationary earth orbit (GEO) satellite. These are typically defined as:
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

A communication satellite typically generates several beams over a given area. The footprint of a beam is usually in an elliptic shape, which has been traditionally considered as a cell. The footprint of a beam is also often referred to as a spotbeam. The footprint of a beam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

Two basic architectures have been considered:
Transparent payload (also referred to as bent pipe architecture). In this architecture the gNB (radio base station in 5G/NR) is located on the ground and the satellite forwards signals/data between the gNB and the user equipment (UE.
Regenerative payload. In this architecture the gNB is located in the satellite.

In the work item for NR NTN in 3GPP release 17, only the transparent architecture is currently being considered.

FIG. 1 shows an example architecture of a satellite network with bent pipe transponders. The base station (e.g., gNB) can be integrated in the gateway or connected to the gateway via a terrestrial connection (wire, optic fiber, wireless link).

Propagation delay is an important aspect of satellite communications and is different from the delay expected in a terrestrial mobile system. For a bent pipe satellite network, the round-trip delay may, due to the orbit height, range from tens of ms in the case of LEO to several hundreds of ms for GEO. This can be compared to the round-trip delays in a cellular network which are limited to 1 ms.

The propagation delay can also be highly variable due to the high velocity of the LEO and MEO satellites and change in the order of 10-100 μs every second, depending on the orbit altitude and satellite velocity.

In the context of propagation delay, the timing advance (TA) the UE uses for its uplink transmissions is essential and has to be much greater than in terrestrial networks in order for the uplink and downlink to be time aligned at the gNB, as is the case in NR and LTE. One of the purposes of the random access (RA) procedure is to provide the UE with a valid TA (which the network later can adjust based on the reception timing of uplink transmission from the UE). However, even the random access preamble (i.e., the initial message from the UE in the random access procedure) has to be transmitted with a timing advance to allow a reasonable size of the RA preamble reception window in the gNB, but this TA does not have to be as accurate as the TA the UE subsequently uses for other uplink transmissions. The TA the UE uses for the RA preamble transmission is called “pre-compensation TA”. Various proposals are considered for how to determine the pre-compensation TA, all of which involves information originating both at the gNB and at the UE. The discussed alternative proposals include:
Broadcast of a “common TA” which is valid at a certain reference point, e.g., a center point in the cell. The UE would then calculate how its own pre-compensation TA deviates from the common TA, based on the difference between the UE's own location and the reference point together with the position of the satellite. Herein, the UE acquires its own position using global navigation satellite system (GNSS) measurements and the UE obtains the satellite position using satellite orbital data (including satellite position at a certain time) broadcast by the network.
The UE autonomously calculates the propagation delay between the UE and the satellite, based on the UE's and the satellite's respective positions, and the network/gNB broadcasts the propagation delay on the feeder link, i.e., the propagation delay between the gNB and the satellite. Herein, the UE acquires its own position using GNSS measurements and the UE obtains the satellite position using satellite orbital data (including satellite position at a certain time) broadcast by the network. The pre-compensation TA is then twice the sum of the propagation delay on the feeder link and the propagation delay between the satellite and the UE.
The gNB broadcasts a timestamp (in SIB9 (session information block #9)), which the UE compares with a reference timestamp acquired from GNSS. Based on the difference between these two timestamps, the UE can calculate the propagation delay between the gNB and the UE, and the pre-compensation TA is twice as long as this propagation delay.

A second important aspect closely related to the timing is a Doppler frequency offset induced by the motion of the satellite. The access link may be exposed to Doppler shift in the order of 10-100 kHz in sub-6 GHz frequency band and proportionally higher in higher frequency bands. Also, the Doppler shift is varying, with a rate of up to several hundred Hz per second in the S-band and several kHz per second in the Ka-band.

Tracking Areas (and Radio Access Network (RAN)-Based Notification Areas)

In terrestrial networks based on NR and LTE, tracking areas are used by the network to coarsely keep track of a UE's whereabouts, especially UE's in RRC_IDLE (radio resource control-idle) or RRC_INACTIVE state. In such terrestrial networks, a tracking area (TA) is a set of cells, and each cell belongs to one and only one TA. A UE can identify the TA a cell belongs from the Tracking Area Identifier (TAI), which consists of the PLMN ID (public land mobile network ID) and a Tracking Area Code (TAC), and which is broadcast in the system information of each cell.

Furthermore, in terrestrial NR and LTE networks, a UE is configured with a list of TAs (in the form of a list of TAIs), representing the area the UE (in RRC_IDLE or RRC_INACTIVE state) is allowed to move around in without informing the network of its location. If the UE moves (re-selects) to a cell that does not belong to any of the TAs in the UE's configured list of TAs, the UE has to inform the network. This process is called Tracking Area Update in LTE (where the UE sends a Tracking Area Update Request NAS (non-access stratum) message) while the corresponding procedure is called Registration in NR/5G (where the UE sends a Registration Request NAS message with the 5GS Registration Type IE (information element) set to “mobility registration updating”). The Tracking Area List (e.g., the list of TAIs) provided to the UE is referred to as a “Registration Area” in 5G.

The tracking area list a UE is configured with is related to core network (CN) initiated paging (i.e., the mechanism by which the network can reach a UE which is in RRC_IDLE state) in the sense that in order to be sure to reach the UE, the CN has to page the UE in all the cells of the TAs in the UE's list of TAs. The CN may page the UE in all these cells at the first page attempt, but the CN may also choose to first page the UE in a smaller number of cells, based on the UE's last known location, and then increase or complement the cells in which the UE is paged in a second attempt in case the UE does not respond to the first page attempt. The CN can also use the UE's current TA for other purposes and therefore the UE's TA, as well as its serving cell ID may be signaled over the RAN-CN (radio access network—core network) interface, e.g., from a gNB to an AMF (access and mobility management function).

In NR, there is also a radio access network (RAN) initiated paging mechanism which is used when the network needs to reach a UE in RRC_INACTIVE state. To support RAN initiated paging, a UE can be configured with a RAN-based Notification Area (RNA) when it is released to RRC_INACTIVE state. An RNA may be a list of cells, a list of RAN Areas (identified by a list of RAN Area Codes (RANACs), which are unique within a TA) or a list of TAs. As long as a UE in RRC_INACTIVE state does not leave its configured RNA it does not have to inform the network of its location, but if it leaves the RAN, it has to contact the network to perform RNA update (i.e., send an RRCResumeRequest message with the ResumeCause IE set to “rna-Update”). During RAN initiated paging the UE is paged in its configured RNA.

In addition to mobility Registration (or Tracking Area Update) and RNA update triggered by UE movements, i.e., a UE leaving its configured RNA or list of TAs, a UE may perform timer controlled periodic Registration (or Tracking Area Update) and periodic RNA update.

3GPP desires to reuse for NTN as much as possible of the standards specified for NR in terrestrial networks, but reusing the above described TA and RNA concepts in Non-Terrestrial Networks is not straightforward, since the satellites are moving relative to earth, cells may be moving and gNBs may be moving. Different concepts have been proposed, including that the TAI (tracking area identity) follows a cell as it moves or that the TAI is fixed to a geographical area and should be adopted and broadcast by the cell passing over the geographical area. The geographically fixed TA concept has the most traction in 3GPP. A similar mechanism is relevant also for earth fixed beams/cells, since the cell covering the cell area may change with satellite and/or feeder link switches (at least conceptually snice such events probably will involve change of the PCI).

In addition, when geographically fixed TAs are used in a moving cells deployment, a cell may have to broadcast multiple TAIs when moving across TA borders. Momentary switching from one TAI to another is referred to as hard TAI update, or hard TAI switch, while broadcasting of multiple (e.g., two) TAIs while a TA border passes through the cell is referred to as soft TAI update, or soft TAI switch.

In a 3GPP email discussion after RAN2 #111-e, the specific aspect for earth moving beams/cells is to be brought up regarding the handling of TAs, TAIs, change/update of TAs, and Registration. During the NTN study item in 3GPP, both hard and soft switch have been considered. Hard switch means that each cell can broadcast only one tracking area code. When this is combined with geographically/earth fixed tracking area, it will create fluctuation at the border areas of these earth fixed tracking areas. Hard TAI update is depicted in FIG. 2, which illustrates a tracking area switch for earth moving beams/cells where the satellites are moving from the right to the left.

Soft TAI update requires the network to broadcast more than one TAI for a cell and PLMN, during a certain period of time. Soft TAI update is depicted in FIG. 3.

3GPP Status

RAN2 reached the following agreements regarding the tracking area management in RAN2 #113:

Agreements:
1. In NTN, the UE determines the TA based on the broadcast information (the use of other information is not excluded). In any case RAN2 will not go in a different direction than other groups
2. In NTN, the network may broadcast more than one TACs per PLMN in a cell, which is to up to network implementation.

Typically the Access Stratum (AS) layer in the UE reads the tracking area from the system information broadcasted by the gNB. The AS layer in the UE then delivers the TAI to the Non-Access Stratum (NAS) layer in the UE, via a UE-internal interface. The NAS layer thus always receives a single current TAI from AS layer. The NAS layer will then check if the TAC reported from the AS layer is included in the UE's current Registration Area (TAI list). If not, the UE will trigger a mobility Registration (Tracking Area Update). If it is in the TAI List, the UE will not trigger a mobility Registration.

A related aspect is that the gNB, when the UE sends a NAS message, include UE Location Information (ULI) in the NG application protocol (NGAP) signaling to the Core Network. This ULI contains the Cell ID and TAI of the UE's current cell.

### SUMMARY

If there are multiple tracking area codes in the system information of one cell it causes a few issues. These issues are:
It is not clear if and how the AS layer and/or the NAS layer in the UE should handle multiple TACs
   If the AS layer selects one TAC and reports to NAS layer in the UE, and this TAC is not in the UE's Registration Area, the NAS layer will trigger mobility Registration even though some other TAC broadcasted by the gNB would be in the UEs' Registration Area.
   If the AS layer instead reports all TAIs to the NAS layer, this breaks the fundamental assumption in the NAS layer that there is always a single current TAI [3GPP TS 24.301, 3GPP TS 24.501].
It is not clear which TAI that the gNB would include in NGAP signaling to the Core Network. If the UE considers itself in one of the TACs broadcasted by the gNB, while the gNB provides a different TAC to the CN/AMF, and the UE performs a Service Request it may cause misalignment where:
   The UE thinks that it is located in a TAI which is in the Registration Area, and there is no need to perform a mobility Registration. In this case the UE may perform a Service Request.
      The AMF thinks that the UE is located in a TAI currently not in the UE's Registration area and should thus perform a mobility Registration and not a Service Request. The AMF may reject the Service Request if the TAC indicated in the UE's Registration area.

Various embodiments of inventive concepts provide various ways to overcome the issues described above and selection one TAC out of multiple broadcasted TACs and align knowledge on what TAC is selected across the UE, RAN and core network (CN).

According to some embodiments, a method performed by a user equipment (UE) includes obtaining tracking area codes, TACs, broadcast in a cell of a network. The method includes responsive to none of the broadcast TACs being a last previously selected TAC in the UE, selecting, by a non-access stratum, NAS, layer or an access stratum, AS, layer of the UE, one TAC of the broadcast TACs to be a current TAC of the UE.

Analogous UEs, computer programs, and computer program products are also provided.

An advantage that may be achieved using the various embodiments of inventive concepts is there is no need to include more than one TAC in NAS signalling.

According to some other embodiments, a method performed by a radio access network (RAN) node includes receiving, from a user equipment (UE), a current tracking area code, TAC, selected by the UE via radio resource control, RRC, signalling. The method includes determining UE location information based on the TAC received from the UE.

Analogous RAN nodes, computer programs, and computer program products are also provided

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an example architecture of a satellite network with bent pipe transponders;

FIG. 2 is an example of a tracking area switch for earth moving beams/cells with a hard TAI update;

FIG. 3 is an example of a tracking area switch for earth moving beams/cells with a soft TAI update;

FIG. 4 is a block diagram illustrating a UE according to some embodiments of inventive concepts;

FIG. 5 is a block diagram illustrating a radio access network RAN node (e.g., a base station eNB/gNB) according to some embodiments of inventive concepts;

FIG. 6 is a block diagram illustrating a core network CN node (e.g., an AMF node, an SMF node, etc.) according to some embodiments of inventive concepts;

FIG. 7 is a signalling diagram illustrating communications between a NAS layer and AS layer of a UE, a gNB and an AMF according to some embodiments of inventive concepts;

FIGS. 8-15 are flow charts illustrating operations of a UE according to some embodiments of inventive concepts;

FIG. 16 is a flow chart illustrating operations of a RAN node according to some embodiments of inventive concepts;

FIG. 17 is a block diagram of a wireless network in accordance with some embodiments;

FIG. 18 is a block diagram of a user equipment in accordance with some embodiments

FIG. 19 is a block diagram of a virtualization environment in accordance with some embodiments;

FIG. 20 is a block diagram of a telecommunication network connected via an intermediate network to a host computer in accordance with some embodiments;

FIG. 21 is a block diagram of a host computer communicating via a base station with a user equipment over a partially wireless connection in accordance with some embodiments;

FIG. 22 is a block diagram of methods implemented in a communication system including a host computer, a base station and a user equipment in accordance with some embodiments;

FIG. 23 is a block diagram of methods implemented in a communication system including a host computer, a base station and a user equipment in accordance with some embodiments;

FIG. 24 is a block diagram of methods implemented in a communication system including a host computer, a base station and a user equipment in accordance with some embodiments; and

FIG. 25 is a block diagram of methods implemented in a communication system including a host computer, a base station and a user equipment in accordance with some embodiments.

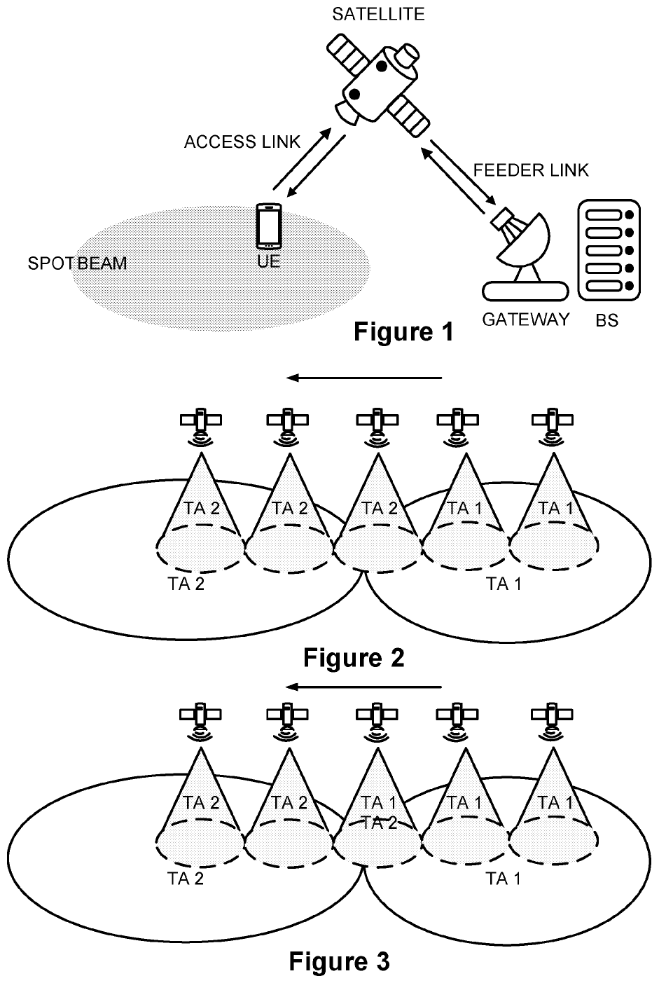

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

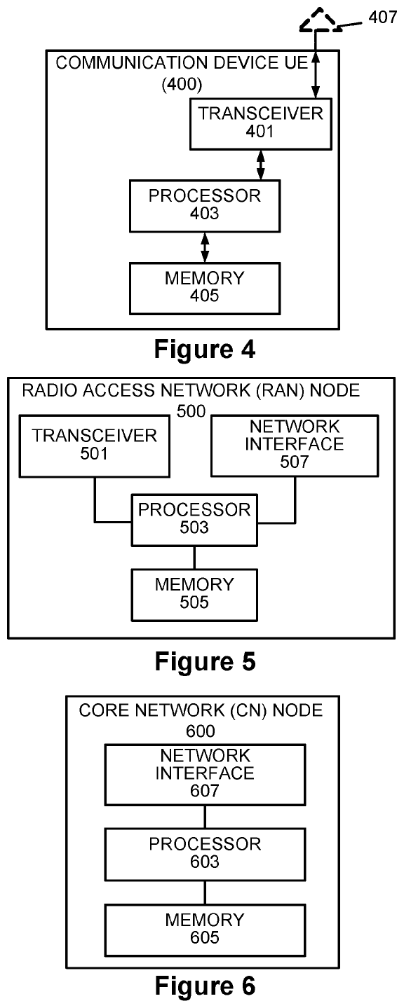

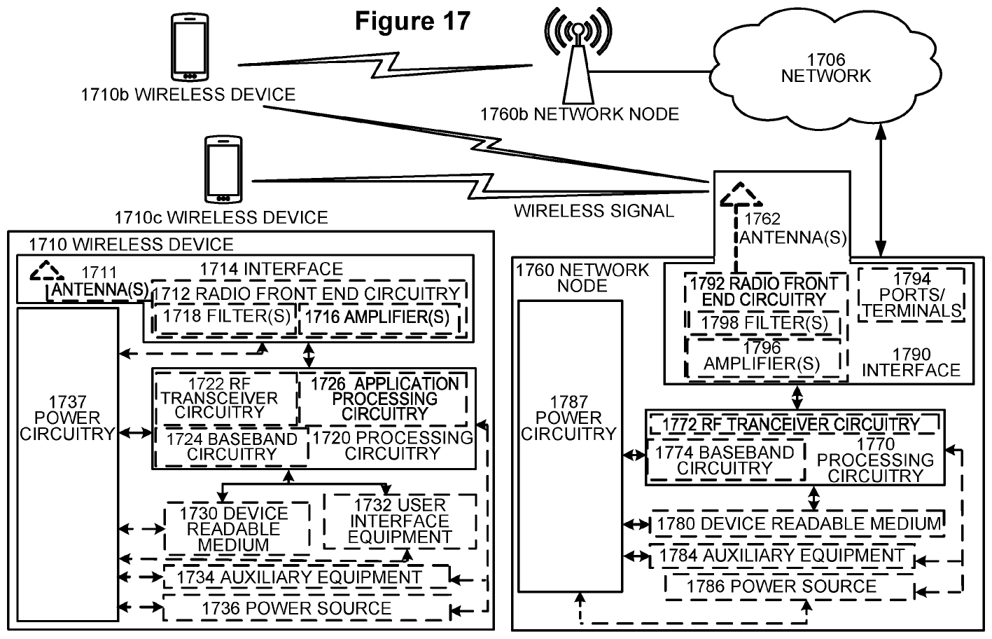

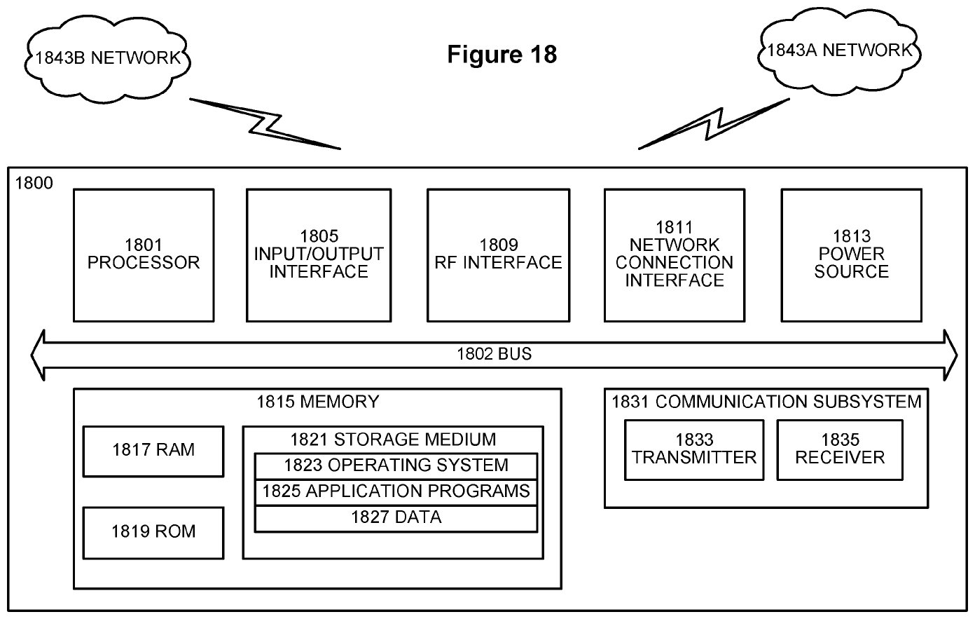

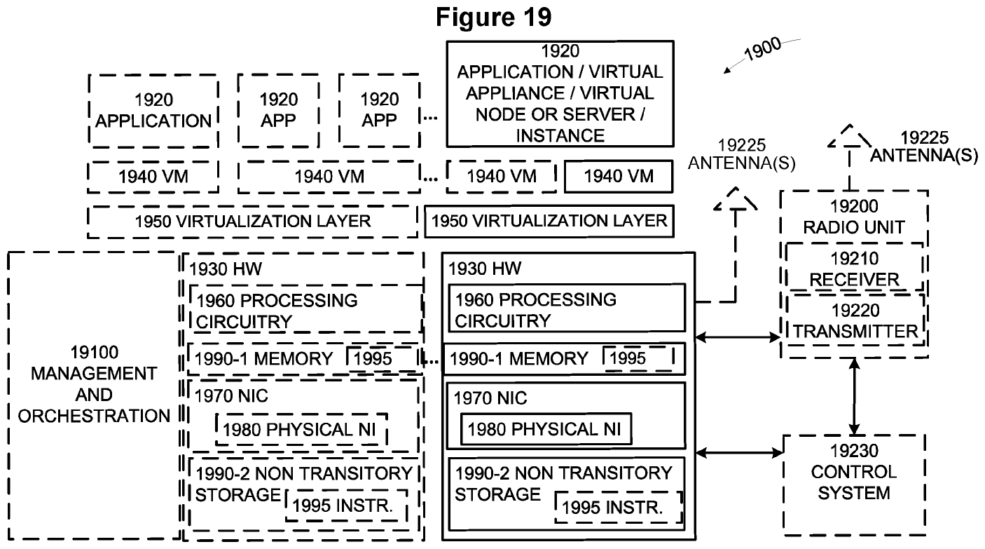

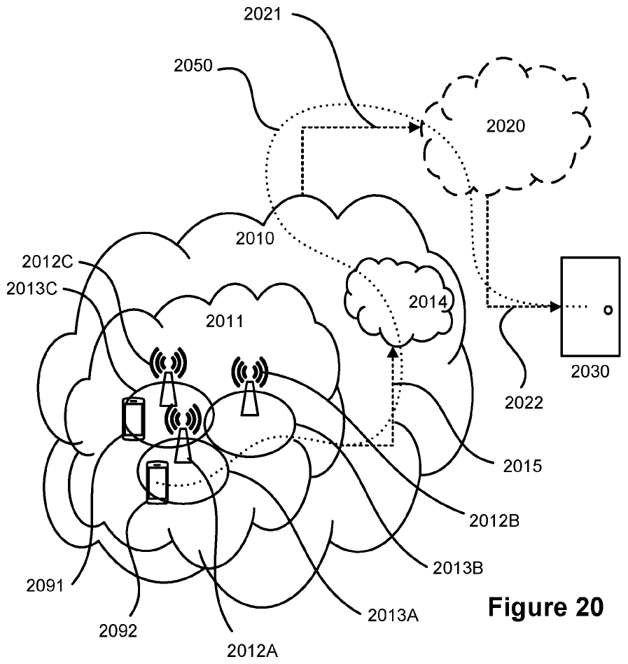

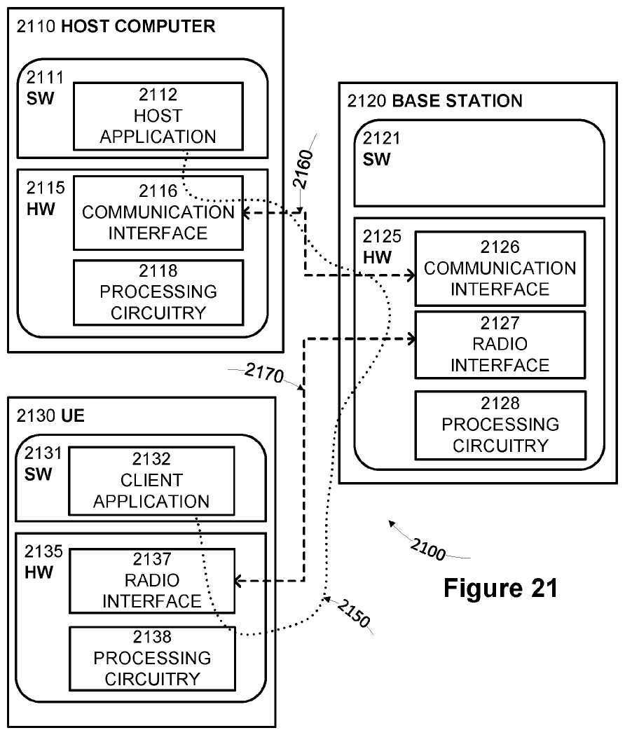

FIG. 4 is a block diagram illustrating elements of a UE 400 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (UE 400 may be provided, for example, as discussed below with respect to wireless device 1710 of FIG. 17, UE 1800 of FIG. 18, virtualization hardware 2030 and virtual machine 1940 of FIG. 19, UEs 2091, 2092 of FIG. 20, and UE 2130 of FIG. 21, all of which should be considered interchangeable in the examples and embodiments described herein and be within the intended scope of this disclosure, unless otherwise noted.) As shown, UE 400 may include an antenna 407 (e.g., corresponding to antenna 1711 of FIG. 17 and/or antenna 19225 of FIG. 19), and transceiver circuitry 401 (also referred to as a transceiver, e.g., corresponding to interface 1714 of FIG. 17, interfaces 1805, 1809, 1811, transmitter 1833 and receiver 1835 of FIG. 18, transmitter 19210 and receiver 19220 of FIG. 19, and radio interface 2137 of FIG. 21) including a transmitter and a receiver configured to provide uplink and downlink radio communications with a base station(s) (e.g., corresponding to network node 1760 of FIG. 17, also referred to as a RAN node) of a radio access network. UE 400 may also include processing circuitry 403 (also referred to as a processor, e.g., corresponding to processing circuitry 1720 of FIG. 17, processor 1801 of FIG. 18, processing circuitry 1960 of FIG. 19, and processing circuitry 2138 of FIG. 21) coupled to the transceiver circuitry, and memory circuitry 405 (also referred to as memory, e.g., corresponding to device readable medium 1730 of FIG. 17 and or memory 1990 of FIG. 19) coupled to the processing circuitry. The memory circuitry 405 may include computer readable program code that when executed by the processing circuitry 403 causes the processing circuitry to perform operations according to embodiments disclosed herein. According to other embodiments, processing circuitry 19 may be defined to include memory so that separate memory circuitry is not required. UE 400 may also include an interface (such as a user interface) coupled with processing circuitry 403, and/or UE 400 may be incorporated in a vehicle.

As discussed herein, operations of UE 400 may be performed by processing circuitry 403 and/or transceiver circuitry 401. For example, processing circuitry 403 may control transceiver circuitry 401 to transmit communications through transceiver circuitry 401 over a radio interface to a radio access network node (also referred to as a base station) and/or to receive communications through transceiver circuitry 401 from a RAN node over a radio interface. Moreover, modules may be stored in memory circuitry 405, and these modules may provide instructions so that when instructions of a module are executed by processing circuitry 403, processing circuitry 403 performs respective operations (e.g., operations discussed below with respect to Example Embodiments relating to UEs). According to some embodiments, a UE 400 and/or an element(s)/function(s) thereof may be embodied as a virtual node/nodes and/or a virtual machine/machines.

FIG. 5 is a block diagram illustrating elements of a radio access network RAN node 500 (also referred to as a network node, base station, eNodeB/eNB, gNodeB/gNB, etc.) of a Radio Access Network (RAN) configured to provide cellular communication according to embodiments of inventive concepts. (RAN node 500 may be provided, for example, as discussed below with respect to network node 1760 of FIG. 17, virtual hardware 1930 or virtual machine 1940 of FIG. 19, base stations 2012A, 2012B, and 2012C of FIG. 20 and/or base station 2120 of FIG. 21, all of which should be considered interchangeable in the examples and embodiments described herein and be within the intended scope of this disclosure, unless otherwise noted.) As shown, the RAN node 500 may include transceiver circuitry 501 (also referred to as a transceiver, e.g., corresponding to portions of interface 1790 of FIG. 17 and/or portions of radio interface 2127 of FIG. 21) including a transmitter and a receiver configured to provide uplink and downlink radio communications with mobile terminals. The RAN node 500 may include network interface circuitry 507 (also referred to as a network interface, e.g., corresponding to portions of interface 1790 of FIG. 17 network interfaces 1970, 1980 of FIG. 19, and/or portions of communication interface 2126 of FIG. 21) configured to provide communications with other nodes (e.g., with other base stations) of the RAN and/or core network CN. The network node may also include processing circuitry 503 (also referred to as a processor, e.g., corresponding to processing circuitry 1770 of FIG. 17 processing circuitry 1960 of FIG. 19 and/or processing circuitry 2128 of FIG. 21) coupled to the transceiver circuitry, and memory circuitry 505 (also referred to as memory, e.g., corresponding to device readable medium 1780 of FIG. 17 and/or memory 1990 of FIG. 19) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the RAN node 500 may be performed by processing circuitry 503, network interface 507, and/or transceiver 501. For example, processing circuitry 503 may control transceiver 501 to transmit downlink communications through transceiver 501 over a radio interface to one or more mobile terminals UEs and/or to receive uplink communications through transceiver 501 from one or more mobile terminals UEs over a radio interface. Similarly, processing circuitry 503 may control network interface 507 to transmit communications through network interface 507 to one or more other network nodes and/or to receive communications through network interface from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to RAN nodes). According to some embodiments, RAN node 500 and/or an element(s)/function(s) thereof may be embodied as a virtual node/nodes and/or a virtual machine/machines.

According to some other embodiments, a network node may be implemented as a core network CN node without a transceiver. In such embodiments, transmission to a UE may be initiated by the network node so that transmission to the UE is provided through a network node including a transceiver (e.g., through a base station or RAN node). According to embodiments where the network node is a RAN node including a transceiver, initiating transmission may include transmitting through the transceiver.

FIG. 6 is a block diagram illustrating elements of a core network (CN) node 600 (e.g., an SMF (session management function) node, an AMF (access and mobility management function) node, etc.) of a communication network configured to provide cellular communication according to embodiments of inventive concepts. (CN node 600 may be provided, for example, as discussed below with respect to network node 1760 of FIG. 17, virtual hardware 1930 or virtual machine 1940 of FIG. 19, all of which should be considered interchangeable in the examples and embodiments described herein and be within the intended scope of this disclosure, unless otherwise noted) As shown, the CN node 600 may include network interface circuitry 607 (also referred to as a network interface e.g., corresponding to portions of interface 1790 of FIG. 17 and/or network interfaces 1970, 1980 of FIG. 19) configured to provide communications with other nodes of the core network and/or the radio access network RAN. The CN 600 node may also include a processing circuitry 603 (also referred to as a processor, e.g., corresponding to processing circuitry 1770 of FIG. 17 and/or processing circuitry 1960 of FIG. 19) coupled to the network interface circuitry, and memory circuitry 505 (also referred to as memory, e.g., corresponding to device readable medium 1780 of FIG. 17 and/or memory 1990 of FIG. 19) coupled to the processing circuitry. The memory circuitry 605 may include computer readable program code that when executed by the processing circuitry 603 causes the processing circuitry to perform operations according to embodiments disclosed herein. According to other embodiments, processing circuitry 603 may be defined to include memory so that a separate memory circuitry is not required.

As discussed herein, operations of the CN node 600 may be performed by processing circuitry 603 and/or network interface circuitry 607. For example, processing circuitry 603 may control network interface circuitry 607 to transmit communications through network interface circuitry 607 to one or more other network nodes and/or to receive communications through network interface circuitry from one or more other network nodes. Moreover, modules may be stored in memory 605, and these modules may provide instructions so that when instructions of a module are executed by processing circuitry 603, processing circuitry 603 performs respective operations (e.g., operations discussed below with respect to Example Embodiments relating to core network nodes). According to some embodiments, CN node 600 and/or an element(s)/function(s) thereof may be embodied as a virtual node/nodes and/or a virtual machine/machines.

As previously indicated, there are multiple tracking area codes in the system information of one cell it causes a few issues. These issues are:
1. It is not clear if and how the AS layer and/or the NAS layer in the UE 400 should handle multiple TACs
   If the AS layer selects one TAC and reports to NAS layer in the UE 400, and this TAC is not in the UE's Registration Area, the NAS layer will trigger mobility Registration even though some other TAC broadcasted by the gNB would be in the UEs' Registration Area.
   If the AS layer instead reports all TAIs to the NAS layer, this breaks the fundamental assumption in the NAS layer that there is always a single current TAI [3GPP TS 24.301, 3GPP TS 24.501].
2. It is not clear which TAI that the gNB would include in NGAP signaling to the Core Network. If the UE 400 considers itself in one of the TACs broadcasted by the gNB, while the gNB provides a different TAC to the CN/AMF, and the UE 400 performs a Service Request it may cause misalignment where:
   The UE 400 thinks that it is located in a TAI which is in the Registration Area, and there is no need to perform a mobility Registration. In this case the UE 400 may perform a Service Request.
   The AMF thinks that the UE 400 is located in a TAI currently not in the UE's Registration area and should thus perform a mobility Registration and not a Service Request. The AMF may reject the Service Request if the TAC indicated in the UE's Registration area.

The various embodiments of inventive concepts are being described mainly in terms of NR based NTNs, but they are equally applicable in an NTN based on LTE technology.

The term “network” is used in the description to refer to a network node, which typically will be a gNB (e.g., in an NR based NTN) or an AMF in 5G, but which may also be an eNB (e.g., in an LTE based NTN) or an MME, or a base station or an access point in another type of network, or any other network node with the ability to communicate directly or indirectly with a UE 400.

Although the various embodiments of inventive concepts are mainly described in terms of RRC_IDLE state and core network initiated paging, the various embodiment are equally applicable to RRC_INACTIVE state and RAN initiated paging.

Global Navigation Satellite Systems (GNSS) can have an important role to play in the various embodiments of inventive concepts. The most well-known GNSS is the American Global Positioning System (GPS), but there are also other also other similar systems which could provide the functionality utilized in the proposed solution, e.g., the Russian Global Navigation Satellite System (GLONASS), the Chinese BeiDou Navigation Satellite System and the European Galileo.

When UE 400 location information or knowledge/information about a UE's location is mentioned, this refers to location or position information that the UE 400 has acquired using GNSS measurements (i.e., regular GNSS positioning or Assisted GNSS measurements), possibly complemented by movement tracking using UE 400 internal sensors, such as accelerometer(s), gyroscope(s) and/or a compass.

The term “location update” is used herein to denote a procedure whereby a UE 400 notifies the network that it has left a previously agreed/configured/allocated area, and which includes that the network, in response, allocates/configures a new such area for the UE 400. In NR, this procedure is a Registration procedure for mobility purpose, which the UE 400 initiates by sending a Registration Request NAS message to the AMF with the 5GS Registration Type IE set to “mobility registration updating”, and the area is a “registration area” consisting of a list of TAs represented by a list of TAIs. In LTE/EPS, this procedure is a Tracking Area Update procedure, which the UE 400 initiates by sending a Tracking Area Update Request NAS message to the MME with the EPS Update Type IE set to “TA updating” (or “Combined TA/LA updating” or “Combined TA/LA updating with IMSI attach”), and the area is a list of TAs represented by a list of TAIs.

The terms “AS layer” and “NAS layer” are used herein to denote logically separate (and even fully or partially physically separate) parts or entities in a UE 400 and could equally well be denoted “AS entity” and “NAS entity”.

The various embodiments of inventive concepts target scenarios where multiple TACs may be broadcasted in a cell and discuss which TAC the AS layer in a UE 400 should report to the NAS layer in the UE 400. It should be noted that a TAC in this context may be seen as representing a TAI, wherein a TAI is the combination of a PLMN ID and a TAC. Hence, when the AS layer is described as selecting and reporting a TAC, this may be seen as equivalent to selecting and reporting a TAI. In addition, as long as a UE 400 remains registered in a PLMN, the PLMN ID part of the TAI will not change even if the TAC part of the TAI is changed, e.g., during cell re-selection or TAI switches in a cell. The multi-TAC broadcast scenarios targeted by the proposed solution are scenarios where multiple TACs associated with the same PLMN (and thus the same PLMN ID) are broadcast in a cell, e.g., because of soft TAI/TAC switches. For instance, a scenario where a cell is shared by PLMN1 and PLMN2 and the gNB broadcasts one TAC associated with PLMN1 and another TAC associated with PLMN2 is not a scenario in which the various embodiments of inventive concepts described herein should be applied. (Cells shared by multiple PLMNs are however not excluded, since the solution may be applied as long as multiple TACs associated with the same PLMN (e.g., the UE's current PLMN) are broadcast (or may be broadcast) in the cell, irrespective of the TAC(s) associated with the other PLMN(s) sharing the cell.)

Broadcasting of TAIs

In one embodiment for solving the first issue, a UE 400 is camping on a cell that broadcasts only TAC1 and TAC1 is in UE's registration area. The next time the UE 400 reads system information both TAC1 and TAC2 are broadcasted. In a first variant, TAC2 is not in its registration area, NAS should not be updated, and the UE 400 would not perform location update either. In a variant, TAC2 is also in UEs registration area but the UE 400 does not update NAS as long as TAC1 is still broadcasted. When TAC1 is not broadcasted but only TAC2, the UE 400 updates NAS and a location update is performed towards the network.

In a second embodiment of inventive concepts, a UE 400 is camping on a cell that broadcasts only TAC1 and TAC1 is in the UE's registration area, and next time UE 400 reads system information, TAC1, TAC2 and TAC3 are broadcasted. In a first variant, TAC2 or TAC3 are not in its registration area, NAS should not be updated, and the UE 400 would not perform location update either. In a variant, TAC2 or TAC3 are also in UEs registration area but UE 400 does not update NAS as long as TAC1 is still broadcasted. When TAC1 is not broadcasted but only TAC2 and/or TAC3, UE 400 updates NAS. If at selection of the TAC to report to NAS the registration area of the UE 400 is known, a TAC present in the registration area can be selected and reported to NAS to avoid that a location update is performed towards the network. If both TACs are present in the registration area, the UE 400 can randomly select a TAC and report to NAS. In a variant such selection is based on a validity timer, if it exists, which indicates how long the TAC is expected to be valid, e.g., whichever TAC has longer validity.

In a third embodiment of inventive concepts, a UE 400 is camping on a cell that broadcasts only TAC1 and TAC1 is in UE's Registration area, next time UE 400 reads system information TAC1 and TAC2 are broadcasted. At any change in the broadcast TACs, the complete TAC list is reported to NAS. NAS selects one of the TACs in the list to be considered as the TAC of the UE 400 location. Other information available in NAS, e.g., TACs in the registration area or the UE's current location (e.g., in case the UE 400 is aware of the geographical definition of the TA borders), can be taken into account at selecting the current TAC in such a way that unnecessary location updates are avoided. In a variant the AS layer is informed regarding the TAC NAS has selected.

In yet another embodiment, if UE 400 powers on in a cell where UE 400 reads more than one TAC, the UE 400 would need to make a selection. In a first variant, one of the broadcasted TACs is selected by wireless device US 400 and indicated to NAS. In a second variant, all broadcast TACs are indicated to NAS and one of the TACs is selected by NAS as the current TAC, optionally taking other information available to NAS into account. The selected TAC, either the TAC indicated to NAS or the TAC selected by NAS, will also be indicated to the network in a subsequent location update procedure. The TAC should be selected to minimize further location updates by the UE 400.

In another embodiment, the AS layer in the UE 400 keeps track of the TAC(s) it has reported to the NAS layer since the last time the UE 400 communicated with the network, or since the last time the NAS layer communicated with the network. If the UE 400 enters a cell where more than one TAC are broadcasted, or the UE 400 is present in a cell when the network starts to broadcast a new TAC in the cell, when selecting the TAC to report to the NAS layer, the AS layer favors selection and reporting of a TAC (out of multiple TACs broadcasted in the UE's current cell) that it has previously reported to the NAS layer since the last time the NAS layer communicated with the network. For instance, if TAC1 and TAC2 are broadcasted in the cell and the AS layer has previously reported TAC1 since the last NAS communication with the network, but not TAC2, then the AS layer will report TAC1 to the NAS layer. If more than one TAC fulfills this requirement, the AS layer may use other criteria (e.g., other herein described criteria) to select between the TACs that fulfill the requirement, or, alternatively, all the TACs that fulfill this requirement may be reported to the NAS layer. Similarly, if none of the broadcasted TACs fulfills this requirement, the AS layer may use other criteria (e.g., other herein described criteria) to select between the TACs, or, alternatively, all the broadcasted TACs may be reported to the NAS layer. The rationale for the AS layer's behavior in this embodiment is that if the AS layer has reported a certain TAC to the NAS layer before, and the NAS layer has not communicated with the network after that, this implies that that TAC did not trigger a location update (e.g. a mobility-triggered Registration procedure, i.e. a Registration Request NAS message from the NAS layer), which in turn implies that the TAI the TAC belongs to is included in the UE's current list of TAIs.

In yet another embodiment, the AS layer bases its selection of TAC (out of multiple TACs broadcasted in the UE's current cell) to report to the NAS layer based on knowledge/information about the UE's location, e.g., combined with knowledge/information about the geographical definition of TA borders. For instance, if TAC1 and TAC2 are broadcasted in the cell and the AS layer, based on UE location information, determines that the UE 400 is located within the TA associated with TAC2, then the AS layer reports TAC2 to the NAS layer.

In yet another embodiment, the AS bases its selection of TAC (out of multiple TACs broadcasted in the UE's current cell) to report to the NAS layer based on knowledge/information about the validity times of the respective TACs, i.e., information about how long the network will keep broadcasting the respective TACs in the cell. This information may come e.g., in the form of validity timers associated with the TACs or information about upcoming TAC switch(es), wherein this information e.g., may be included by in the broadcasted system information in the cell. For instance, when this information is available to the AS layer, the AS layer may choose to report to the NAS layer the one of the broadcast TACs that the network will keep broadcasting for the longest time (e.g., the TAC whose associated validity timer indicates the longest remaining validity time). When applying this selection principle, the AS layer may also take into account circumstances which may motivate exceptions to the rule. For instance, if the UE 400 is located in a cell when the network starts broadcasting a new TAC in the cell, in addition to the TAC(s) that was/were already broadcast in the cell, the AS layer may choose not to report the new TAC to the NAS layer even if the new TAC has the longest remaining validity time. The rationale for this is that the TAC the AS layer has previously reported to the NAS layer (and which the NAS layer consequently considers as the current valid TAC) can be assumed to be associated with a TA that is included in the UE's allocated list of TA(s) (i.e. the TAC can be assumed to be part of a TAI that is included in the UE's allocated list of TAI(s)). In yet another embodiment, the UE 400 indicates to gNB via RRC signalling which TAC is considered the current TAC by the UE 400.

In one embodiment for solving the second issue, the UE 400 will indicate via RRC signalling to gNB which TAC, out of the multiple TACs that were broadcasted, the UE 400 considers to be the current TAC. The gNB will use this information when determining the TAC to include in the ULI information in NGAP. In this way it is ensured that the UE's view of current TAC and the networks' view of the UE's current TAC are aligned.

Another embodiment for the second issue is that UE 400 does not report its selected current TAC to gNB. Instead gNB selects one TAC and provides to AMF in NGAP signaling. In this case the TAC used by the UE 400 may be different than the TAC reported by gNB to AMF. In order to handle this case, the AMF should accept a Service Request even if the gNB reports a UE's current TAC that is outside the current Registration Area. The AMF can be configured with information that such approach is allowed when UE 400 accesses the network via specific cell that is signalled to AMF in NGAP.

In yet another embodiment for the second issue, the UE 400 signals the selected TAC in the Service Request and location update message on NAS layer and that TAC value is considered by the AMF while the TAC selected by gNB and provided in the NGAP to AMF is not considered. In this case the AMF can provide the TAC signaled by the wireless device US 400 in NAS to gNB in NGAP, e.g., Initial UE Context Request message.

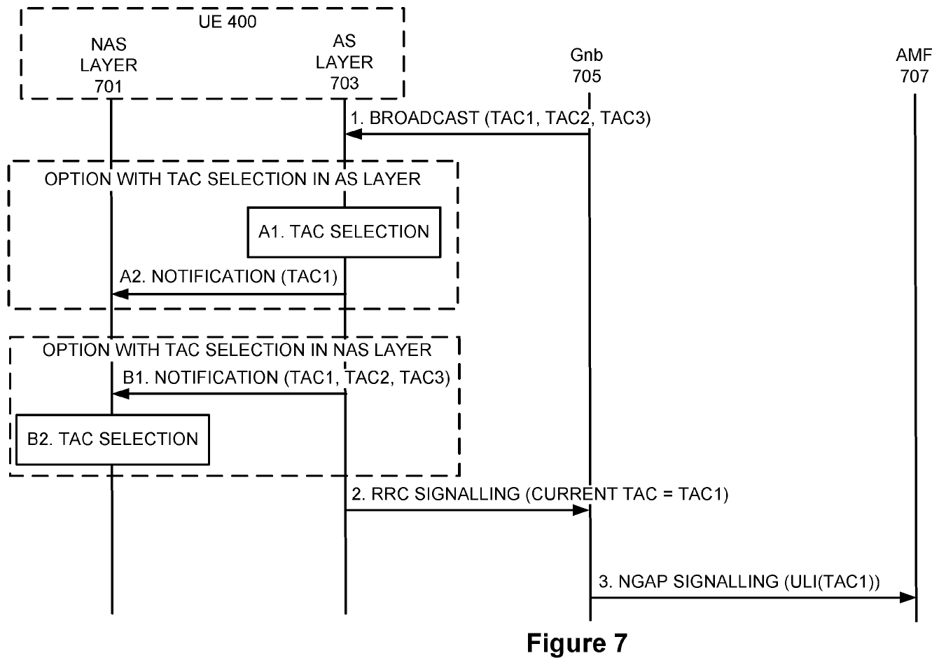

FIG. 7 illustrates the signalling that occurs in the various embodiments of inventive concepts described above. Turning to FIG. 7, in step 1, the gNB broadcasts the TACS currently active in the cell

In the option with TAC selection in AS layer:
A1: the AS layer selects a TAC, as described in embodiments described above
A2: the AS layer reports a single TAC to the NAS layer, as per current specifications

In the option with TAC selection in NAS layer:
B1: the AS provides multiple TAC values to the NAS layer
B2: the NAS layer selects a TAC, based on embodiments described above
B3: the NAS layer indicates to AS layer which TAC it is considering as current TAC

In step 2, The UE 400 may provide the selected current TAC to the gNB via RRC signalling

In step 3, the gNB provides the UE Location Information, including TAI, to AMF.

The gNB determines the UE Location Information based on the TAC provided by the UE in step 2.

Note: not all steps in the above call flow need to be present. For example, in case UE 400 does not report current TAC in step 2, then gNB determines ULI without knowledge of the current TAC selected by the UE 400. In this case AMF need to accept a Service Request from a UE 400 even if the ULI contains a TAC not in the UE's Registration Area.

In any of the above embodiments or embodiment variants where the UE 500 (the AS layer or the NAS layer) utilizes information/knowledge about the geographical definition of TA border(s), this information/knowledge may have been provided to the UE 400 through configuration from the network, where the network may convey the information/knowledge e.g., in the broadcast system information or using NAS signaling, e.g., in a Registration Accept NAS message.

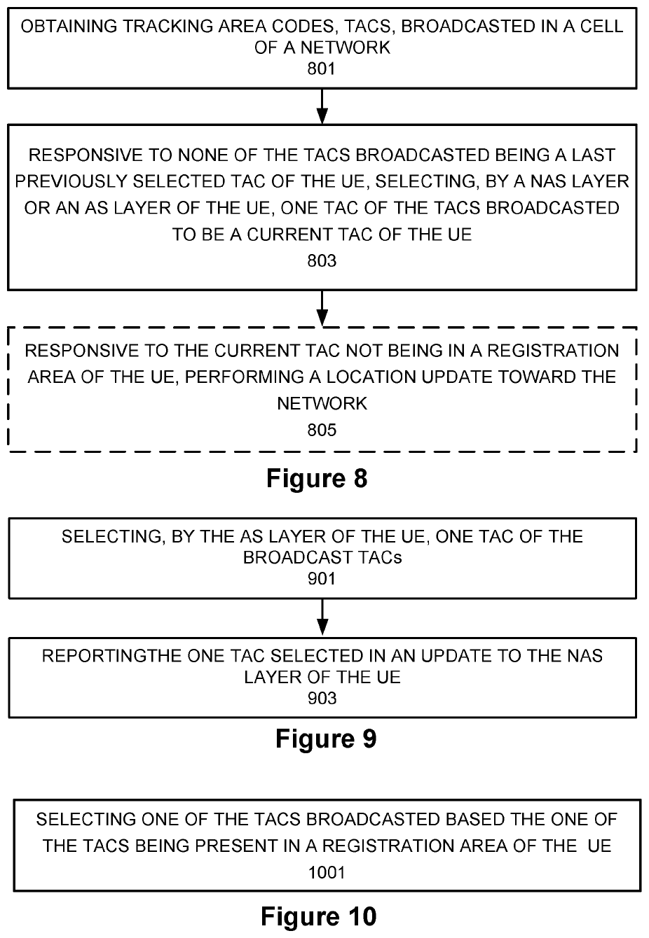

In the description that follows, while the UE may be any of the UE 400, wireless device 1710, the UE 1800, UEs 2091, 2092, virtual hardware 1930, virtual machine 1940, or UE 2130, the UE 400 shall be used to describe the functionality of the operations of the UE 400. Operations of the UE 400 (implemented using the structure of the block diagram of FIG. 4) will now be discussed with reference to the flow chart of FIG. 8 according to some embodiments of inventive concepts. For example, modules may be stored in memory 405 of FIG. 4, and these modules may provide instructions so that when the instructions of a module are executed by respective communication device processing circuitry 403, processing circuitry 403 performs respective operations of the flow chart.

FIG. 8 illustrates operations a UE 400 performs in handling of multiple broadcasted tracking areas codes. Turning to FIG. 8, in block 801, the processing circuitry 403 obtains tracking area codes (TACs) broadcasted in a cell of a network. The cell is the cell the UE 400 is currently located within.

Responsive to none of the TACs broadcasted being a last previously selected TAC in the UE 400, the processing circuitry 403 in block 803, via the NAS layer 701 or the AS layer 703, selects one TAC of the TACs broadcasted to be a current TAC of the UE 400. In block 805, the processing circuitry 403, responsive to the current TAC not being in a registration area of the UE 400, performs a location update towards the network. The location update has been described above.

Various operations from the flow chart of FIG. 8 may be optional with respect to some embodiments of communication devices and related methods. Regarding methods of example embodiment 1 (set forth below), for example, operations of block 803 of FIG. 8 may be optional.

As described above, selecting a TAC can be performed by the AS layer 703 or by the NAS layer 701. FIGS. 9-13 describe operations in various embodiments of inventive concepts of the NAS layer 701 and the AS layer 703 of the UE 400 performing the selection of a TAC.

Turning to FIG. 9, in block 901, the processing circuitry 403 reports, by the AS layer 703, a list of broadcast TACs to the NAS layer 701. In block 903, the processing circuitry 403 selects, by the NAS layer 701, one TAC of the broadcast TACs in the cell. Turning briefly to FIG. 10, in some embodiments of inventive concepts, selecting the one TAC of the TACs broadcasted includes selecting in block 1001 one of the TACS broadcasted based the one of the TACs being present in a registration area of the UE 400. For example, if the TACs broadcasted include TAC2, TAC3, and TAC4 and TAC3 is in a registration area (e.g., in a list of tracking area identities (TAIs)) of the UE 400, TAC3 is selected.

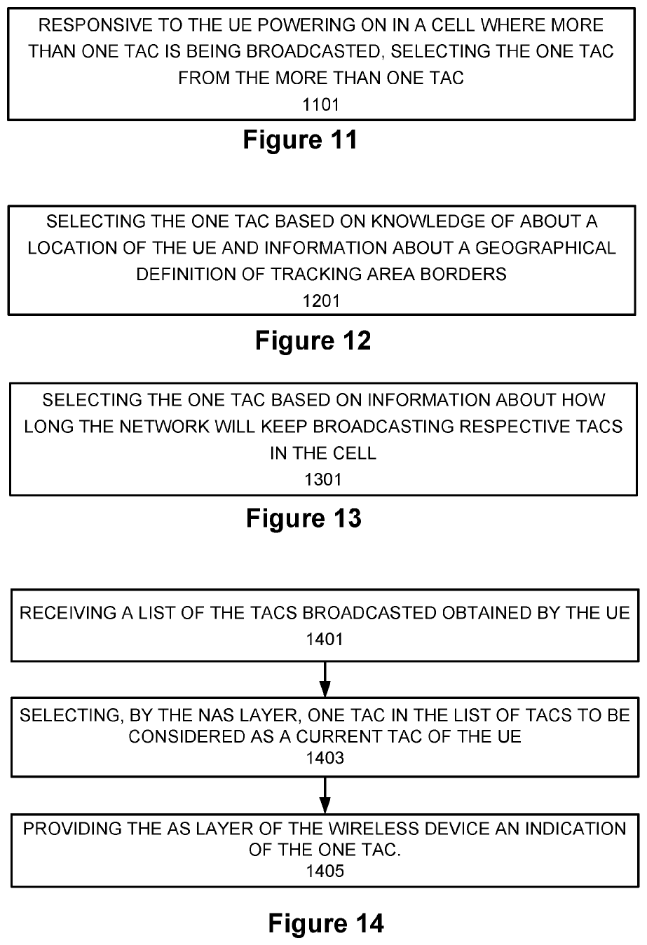

Turing to FIG. 11, in some embodiments of inventive concepts, there may be more than one TAC present when the UE 400 powers on. In block 1101, responsive to the UE 400 powering on in a cell where more than one TAC is being broadcasted, the AS layer 703 selects the one TAC from the more than one TAC.

Turning to FIG. 12, in other embodiments of inventive concepts, in block 1201, the AS layer 703 selects the one TAC based on knowledge of about a location of the UE 400 and information about a geographical definition of tracking area borders.

Turing to FIG. 13, in yet other embodiments of inventive concepts, in block 1301, the AS layer 703 selects the one TAC based on information about how long the network will keep broadcasting respective TACs in the cell. Further details are described above.

In the embodiments described in FIGS. 11-13, in one embodiment of inventive concepts, in selecting the one TAC, the AS layer 703 favors selection and reporting of a TAC that the AS layer 703 previously reported to the NAS layer 701 since a last time the NAS layer 701 communicated with the network.

FIG. 14 describes operations of various embodiments of inventive concepts of the NAS layer 703 of the UE 400 performing the selection of a TAC.

Turing to FIG. 14, in block 1401, the processing circuitry 403, receives, by the NAS layer 701, a list of the broadcast TACs. In some embodiments, the AS layer 703 provides the list of the broadcast TACs to the NAS layer 701. In some embodiments, the NAS layer receives the list of the TACs broadcasted whenever there is a change in the list of the TACs broadcasted.

In block 1403, the processing circuitry 403, via the NAS layer 701, selects one TAC in the list of TACs to be considered as a current TAC of the UE 400. Selecting the one TAC in some embodiments is based on information available to the NAS layer 701 of the UE 400. The information in some embodiments of inventive concepts is an identification of TACs in the registration area of the UE 400. For example, the NAS layer 701 may select a TAC in the registration area (e.g., in the list of TAIs) over TACs not in the registration area. In other embodiments of inventive concepts, the information is a geographical definition of tracking area borders. In yet other embodiments, the processing circuitry 403, via the NAS layer 701, selects the one TAC to minimize further location updates by the UE 400.

In block 1405, the processing circuitry 403 proves the AS layer 703 of the UE 400 an indication of the one TAC.

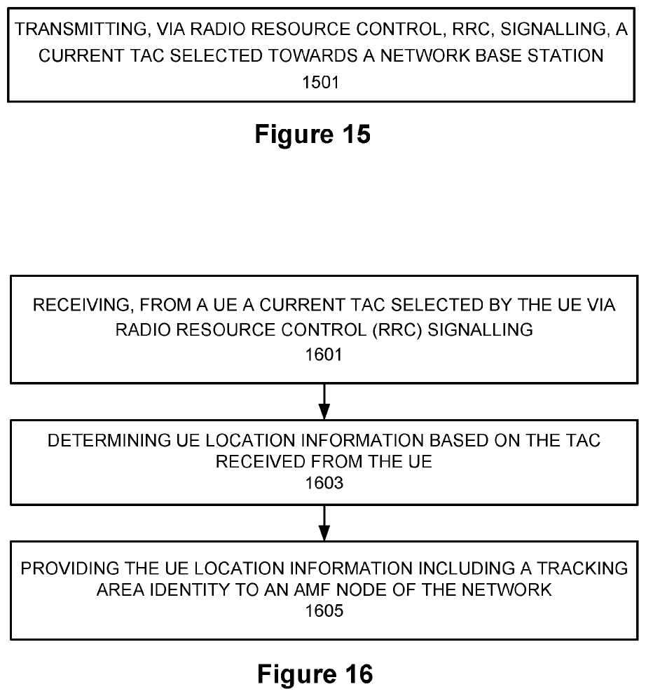

Turing to FIG. 15, in block 1501, the processing circuitry 403 transmits, via RRC signalling, a current TAC selected towards a network base station.

In the description that follows, while the network node may be any of the RAN node 400, the network node 1760, base stations 2012, the host computer 2030, or the base station 2120, the RAN node 400 shall be used to describe the functionality of the operations of the network node. Operations of the RAN node 400 (implemented using the structure of FIG. 5) will now be discussed with reference to the flow chart of FIG. 16 according to some embodiments of inventive concepts. For example, modules may be stored in memory 505 of FIG. 5, and these modules may provide instructions so that when the instructions of a module are executed by respective RAN node processing circuitry 503, processing circuitry 503 performs respective operations of the flow chart.

Turning to FIG. 16, in block 1601, the processing circuitry 503 receives, from a UE 400, a current tracking area code (TAC) selected by the UE 400 via RRC signalling. In block 1603, the processing circuitry 503 determines UE location information based on the TAC received from the UE 400. For example, the TAC is broadcast within a geographical area and the UE 400 using the TAC as a current TAC indicates the UE is within the geographical area. In block 1605, the processing circuitry 503 provides the UE location information including a tracking area identity to an AMF node 707 of the network.

Various operations from the flow chart of FIG. 16 may be optional with respect to some embodiments of RAN nodes and related methods. Regarding methods of example embodiment 21 (set forth below), for example, operations of block 1605 of FIG. 16 may be optional.

Example embodiments are discussed below.
Embodiment 1. A method performed by a user equipment, UE, (400, 1800, 1930, 1940, 2091, 2092, 2130) comprising:
   obtaining (801) tracking area codes, TACs, broadcasted in a cell of a network; and
   responsive to none of the TACs broadcasted being a last previously selected TAC in the UE (400, 1800, 1930, 1940, 2091, 2092, 2130), selecting (803), by a non-access stratum, NAS, layer (701) or an access stratum, AS, layer (703) of the UE (400, 1800, 1930, 1940, 2091, 2092, 2130), one TAC of the TACs broadcasted to be a current TAC of the UE (400, 1800, 1930, 1940, 2091, 2092, 2130).
Embodiment 2. The method of Embodiment 1, further comprising:
   responsive to the current TAC not being in a registration area of the UE (400, 1800, 1930, 1940, 2091, 2092, 2130), performing (805) a location update towards the network.
Embodiment 3. The method of any of Embodiments 1-2, wherein selecting, by the NAS layer (701) or the AS layer (703) the one TAC comprises:
   selecting (901), by the AS layer (703), the one TAC of the TACs broadcasted; and
   reporting (903) the one TAC selected in an update to the NAS layer (701) of the UE (400, 1800, 1930, 1940, 2091, 2092, 2130).
Embodiment 4. The method of Embodiment 3, wherein selecting the one TAC of the TACs broadcasted comprises:
   selecting (1001) one of the TACS broadcasted based the one of the TACs being present in a registration area of the UE (400, 1800, 1930, 1940, 2091, 2092, 2130).
Embodiment 5. The method of Embodiment 3, wherein selecting the one TAC of the TACs broadcasted comprises:
   responsive to the UE (400, 1800, 1930, 1940, 2091, 2092, 2130) powering on in a cell where more than one TAC is being broadcasted, selecting (1101) the one TAC from the more than one TAC.
Embodiment 6. The method of Embodiment 2 wherein selecting the one TAC of the TACs broadcasted comprises selecting (1201) the one TAC based on knowledge of about a location of the UE (400, 1800, 1930, 1940, 2091, 2092, 2130) and information about a geographical definition of tracking area borders.
Embodiment 7. The method of Embodiment 2, wherein selecting, by the AS layer (703), the one TAC of the TACs broadcasted comprises selecting (1301) the one TAC based on information about how long the network will keep broadcasting respective TACs in the cell.
Embodiment 8. The method of any of Embodiments 1-8, wherein in selecting the one TAC, the AS layer (703) favors selection and reporting of a TAC that the AS layer (703) previously reported to the NAS layer (701) since a last time the NAS layer (701) communicated with the network.
Embodiment 9. The method of Embodiment 1, wherein selecting, by the NAS layer (701) or the AS layer (703) the one TAC comprises selecting, by the NAS layer (701) the one TAC of the TACs broadcasted.
Embodiment 10. The method of Embodiment 10, wherein selecting, by the NAS layer (701) the one TAC of the TACs broadcasted comprises:
   receiving (1401), by the NAS layer (701), a list of the TACs being broadcasted to the NAS layer (701) of the UE (400, 1800, 1930, 1940, 2091, 2092, 2130);
   selecting (1403), by the NAS layer (701) of the UE (400, 1800, 1930, 1940, 2091, 2092, 2130), one TAC in the list of TACs to be considered as a current TAC of the UE (400, 1800, 1930, 1940, 2091, 2092, 2130); and
   providing (1405) an access stratum, AS, layer (703) of the wireless device (400, 1800, 1930, 1940, 2091, 2092, 2130) an indication of the one TAC.
Embodiment 11. The method of Embodiment 10 wherein receiving, by the NAS layer (701), the list of the TACs comprises receiving the list of TACs responsive to there being a change in the TACs obtained.
Embodiment 12. The method of any of Embodiments 10-11 wherein selecting the one TAC comprises selecting the one TAC based on information available to the NAS layer (701) of the UE (400, 1800, 1930, 1940, 2091, 2092, 2130).
Embodiment 13. The method of Embodiment 12 wherein the information comprises an identification of TACs in the registration area of the UE (400, 1800, 1930, 1940, 2091, 2092, 2130).
Embodiment 14. The method of Embodiment 12 wherein the information comprises a geographical definition of tracking area borders.
Embodiment 15. The method of any of Embodiments 10-12 wherein selecting the one TAC comprises selecting the one TAC to minimize further location updates by the UE (400, 1800, 1930, 1940, 2091, 2092, 2130).
Embodiment 16. The method of any of Embodiments 1-15, further comprising:
   transmitting (1501), via radio resource control, RRC, signalling, a current TAC selected towards a network base station (500, 1930, 1940, 2012A, 2012B, 2012C, 2120).
Embodiment 17. A user equipment, UE (400, 1800, 1930, 1940, 2091, 2092, 2130) comprising:
   processing circuitry (403, 1720, 1801, 1960 2138); and
   memory (405, 1730, 1815) coupled with the processing circuitry, wherein the memory includes instructions that when executed by the processing circuitry causes the UE to perform operations according to any of Embodiments 1-16.
Embodiment 18. A user equipment, UE, (400, 1800, 1930, 1940, 2091, 2092, 2130) adapted to perform according to any of Embodiments 1-16.
Embodiment 19. A computer program comprising program code to be executed by processing circuitry (403, 1720, 1801, 1960, 2138) of a user equipment, UE, (400, 1800, 1930, 1940, 2091, 2092, 2130), whereby execution of the program code causes the UE (400, 1800, 1930, 1940, 2091, 2092, 2130) to perform operations according to any of Embodiments 1-16. Embodiment 20. A computer program product comprising a non-transitory storage medium including program code to be executed by processing circuitry (403, 1720, 1801, 1960, 2138) of a user equipment, UE, (400, 1800, 1930, 1940, 2091, 2092, 2130), whereby execution of the program code causes the user equipment UE (400, 1800, 1930, 1940, 2091, 2092, 2130) to perform operations according to any of Embodiments 1-16.
Embodiment 21. A method performed by a radio access network, RAN, node (500, 705, 1930, 1940, 2012A, 2012B, 2012C, 2120) in a network, the method comprising:
   receiving (1601), from a user equipment, UE, (400, 1800, 1930, 1940, 2091, 2092, 2130) a current tracking area code, TAC, selected by the UE (400, 1800, 1930, 1940, 2091, 2092, 2130) via radio resource control, RRC, signalling; and determining (1603) UE location information based on the TAC received from the UE (400, 1800, 1930, 1940, 2091, 2092, 2130).
Embodiment 22. The method of Embodiment 21, further comprising:
   providing (1605) the UE location information including a tracking area identity to an access and mobility management function, AMF, node (707) of the network.
Embodiment 23. A radio access network, RAN, node (500, 705, 1930, 1940, 2012A, 2012B, 2012C, 2120) comprising:
   processing circuitry (503, 1770, 1960, 2128); and
   memory (505, 1780, 1990) coupled with the processing circuitry, wherein the memory includes instructions that when executed by the processing circuitry causes the RAN node to perform operations according to any of Embodiments 21-22.
Embodiment 24. A radio access network, RAN, node (500, 705, 1930, 1940, 2012A, 2012B, 2012C, 2120) adapted to perform according to any of Embodiments 21-22. Embodiment 25. A computer program comprising program code to be executed by processing circuitry (503, 1770, 1960, 2128) of a radio access network, RAN, node (500, 705, 1930, 1940, 2012A, 2012B, 2012C, 2120), whereby execution of the program code causes the RAN node (500, 705, 1930, 1940, 2012A, 2012B, 2012C, 2120) to perform operations according to any of Embodiments 21-22.
Embodiment 26. A computer program product comprising a non-transitory storage medium including program code to be executed by processing circuitry (503, 1770, 1950 2128) of a radio access network, RAN, node (500, 705, 1930, 1940, 2012A, 2012B, 2012C, 2120), whereby execution of the program code causes the RAN node (500, 705, 1930, 1940, 2012A, 2012B, 2012C, 2120) to perform operations according to any of Embodiments 21-22.

References are identified below.
3GPP TR 38.811 V15.4.0 (2020-09) 3rd Generation Partnership Project; Technical Specification Group Radio Access Network; Study on New Radio (NR) to support non-terrestrial networks (Release 15)

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 17 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 17. For simplicity, the wireless network of FIG. 17 only depicts network 1706, network nodes 1760 and 1760B, and WDs 1710, 1710B, and 1710C (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 1760 and wireless device (WD) 1710 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1760 and WD 1710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., mobile switching centers (MSCs), mobile management entities (MMEs)), operation and maintenance (O&M) nodes, operations support system (OSS) nodes, self-optimizing network (SON) nodes, positioning nodes (e.g., evolved-serving mobile location centers (E-SMLCs)), and/or minimization of drive tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 17, network node 1760 includes processing circuitry 1770, device readable medium 1780, interface 1790, auxiliary equipment 1784, power source 1786, power circuitry 1787, and antenna 1762. Although network node 1760 illustrated in the example wireless network of FIG. 17 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1760 are depicted as single boxes located within a larger box, or nested within multiple boxes, in practice, a network node may comprise multiple different physical components that make up a single illustrated component (e.g., device readable medium 1780 may comprise multiple separate hard drives as well as multiple RAM modules).

Similarly, network node 1760 may be composed of multiple physically separate components (e.g., a NodeB component and a RNC component, or a BTS component and a BSC component, etc.), which may each have their own respective components. In certain scenarios in which network node 1760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1760 may be configured to support multiple radio access technologies (RATs). In such embodiments, some components may be duplicated (e.g., separate device readable medium 1780 for the different RATs) and some components may be reused (e.g., the same antenna 1762 may be shared by the RATs). Network node 1760 may also include multiple sets of the various illustrated components for different wireless technologies integrated into network node 1760, such as, for example, GSM, wide code division multiplexing access (WCDMA), LTE, NR, WiFi, or Bluetooth wireless technologies. These wireless technologies may be integrated into the same or different chip or set of chips and other components within network node 1760.

Processing circuitry 1770 is configured to perform any determining, calculating, or similar operations (e.g., certain obtaining operations) described herein as being provided by a network node. These operations performed by processing circuitry 1770 may include processing information obtained by processing circuitry 1770 by, for example, converting the obtained information into other information, comparing the obtained information or converted information to information stored in the network node, and/or performing one or more operations based on the obtained information or converted information, and as a result of said processing making a determination.

Processing circuitry 1770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1760 components, such as device readable medium 1780, network node 1760 functionality. For example, processing circuitry 1770 may execute instructions stored in device readable medium 1780 or in memory within processing circuitry 1770. Such functionality may include providing any of the various wireless features, functions, or benefits discussed herein. In some embodiments, processing circuitry 1770 may include a system on a chip (SOC).

In some embodiments, processing circuitry 1770 may include one or more of radio frequency (RF) transceiver circuitry 1772 and baseband processing circuitry 1774. In some embodiments, radio frequency (RF) transceiver circuitry 1772 and baseband processing circuitry 1774 may be on separate chips (or sets of chips), boards, or units, such as radio units and digital units. In alternative embodiments, part or all of RF transceiver circuitry 1772 and baseband processing circuitry 1774 may be on the same chip or set of chips, boards, or units

In certain embodiments, some or all of the functionality described herein as being provided by a network node, base station, eNB or other such network device may be performed by processing circuitry 1770 executing instructions stored on device readable medium 1780 or memory within processing circuitry 1770. In alternative embodiments, some or all of the functionality may be provided by processing circuitry 1770 without executing instructions stored on a separate or discrete device readable medium, such as in a hard-wired manner. In any of those embodiments, whether executing instructions stored on a device readable storage medium or not, processing circuitry 1770 can be configured to perform the described functionality. The benefits provided by such functionality are not limited to processing circuitry 1770 alone or to other components of network node 1760, but are enjoyed by network node 1760 as a whole, and/or by end users and the wireless network generally.

Device readable medium 1780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1770. Device readable medium 1780 may store any suitable instructions, data or information, including a computer program, software, an application including one or more of logic, rules, code, tables, etc. and/or other instructions capable of being executed by processing circuitry 1770 and, utilized by network node 1760. Device readable medium 1780 may be used to store any calculations made by processing circuitry 1770 and/or any data received via interface 1790. In some embodiments, processing circuitry 1770 and device readable medium 1780 may be considered to be integrated.

Interface 1790 is used in the wired or wireless communication of signalling and/or data between network node 1760, network 1706, and/or WDs 1710. As illustrated, interface 1790 comprises port(s)/terminal(s) 1794 to send and receive data, for example to and from network 1706 over a wired connection. Interface 1790 also includes radio front end circuitry 1792 that may be coupled to, or in certain embodiments a part of, antenna 1762. Radio front end circuitry 1792 comprises filters 1798 and amplifiers 1796. Radio front end circuitry 1792 may be connected to antenna 1762 and processing circuitry 1770. Radio front end circuitry may be configured to condition signals communicated between antenna 1762 and processing circuitry 1770. Radio front end circuitry 1792 may receive digital data that is to be sent out to other network nodes or WDs via a wireless connection. Radio front end circuitry 1792 may convert the digital data into a radio signal having the appropriate channel and bandwidth parameters using a combination of filters 1798 and/or amplifiers 1796. The radio signal may then be transmitted via antenna 1762. Similarly, when receiving data, antenna 1762 may collect radio signals which are then converted into digital data by radio front end circuitry 1792. The digital data may be passed to processing circuitry 1770. In other embodiments, the interface may comprise different components and/or different combinations of components.

In certain alternative embodiments, network node 1760 may not include separate radio front end circuitry 1792, instead, processing circuitry 1770 may comprise radio front end circuitry and may be connected to antenna 1762 without separate radio front end circuitry 1792. Similarly, in some embodiments, all or some of RF transceiver circuitry 1772 may be considered a part of interface 1790. In still other embodiments, interface 1790 may include one or more ports or terminals 1794, radio front end circuitry 1792, and RF transceiver circuitry 1772, as part of a radio unit (not shown), and interface 1790 may communicate with baseband processing circuitry 1774, which is part of a digital unit (not shown).

Antenna 1762 may include one or more antennas, or antenna arrays, configured to send and/or receive wireless signals. Antenna 1762 may be coupled to radio front end circuitry 1792 and may be any type of antenna capable of transmitting and receiving data and/or signals wirelessly. In some embodiments, antenna 1762 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1762 may be separate from network node 1760 and may be connectable to network node 1760 through an interface or port.

Antenna 1762, interface 1790, and/or processing circuitry 1770 may be configured to perform any receiving operations and/or certain obtaining operations described herein as being performed by a network node. Any information, data and/or signals may be received from a wireless device, another network node and/or any other network equipment. Similarly, antenna 1762, interface 1790, and/or processing circuitry 1770 may be configured to perform any transmitting operations described herein as being performed by a network node. Any information, data and/or signals may be transmitted to a wireless device, another network node and/or any other network equipment.

Power circuitry 1787 may comprise, or be coupled to, power management circuitry and is configured to supply the components of network node 1760 with power for performing the functionality described herein. Power circuitry 1787 may receive power from power source 1786. Power source 1786 and/or power circuitry 1787 may be configured to provide power to the various components of network node 1760 in a form suitable for the respective components (e.g., at a voltage and current level needed for each respective component). Power source 1786 may either be included in, or external to, power circuitry 1787 and/or network node 1760. For example, network node 1760 may be connectable to an external power source (e.g., an electricity outlet) via an input circuitry or interface such as an electrical cable, whereby the external power source supplies power to power circuitry 1787. As a further example, power source 1786 may comprise a source of power in the form of a battery or battery pack which is connected to, or integrated in, power circuitry 1787. The battery may provide backup power should the external power source fail. Other types of power sources, such as photovoltaic devices, may also be used.

Alternative embodiments of network node 1760 may include additional components beyond those shown in FIG. 17 that may be responsible for providing certain aspects of the network node's functionality, including any of the functionality described herein and/or any functionality necessary to support the subject matter described herein. For example, network node 1760 may include user interface equipment to allow input of information into network node 1760 and to allow output of information from network node 1760. This may allow a user to perform diagnostic, maintenance, repair, and other administrative functions for network node 1760.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1710 includes antenna 1711, interface 1714, processing circuitry 1720, device readable medium 1730, user interface equipment 1732, auxiliary equipment 1734, power source 1736 and power circuitry 1737. WD 1710 may include multiple sets of one or more of the illustrated components for different wireless technologies supported by WD 1710, such as, for example, GSM, WCDMA, LTE, NR, WiFi, WiMAX, or Bluetooth wireless technologies, just to mention a few. These wireless technologies may be integrated into the same or different chips or set of chips as other components within WD 1710.

Antenna 1711 may include one or more antennas or antenna arrays, configured to send and/or receive wireless signals, and is connected to interface 1714. In certain alternative embodiments, antenna 1711 may be separate from WD 1710 and be connectable to WD 1710 through an interface or port. Antenna 1711, interface 1714, and/or processing circuitry 1720 may be configured to perform any receiving or transmitting operations described herein as being performed by a WD. Any information, data and/or signals may be received from a network node and/or another WD. In some embodiments, radio front end circuitry and/or antenna 1711 may be considered an interface.

As illustrated, interface 1714 comprises radio front end circuitry 1712 and antenna 1711. Radio front end circuitry 1712 comprise one or more filters 1718 and amplifiers 1716. Radio front end circuitry 1712 is connected to antenna 1711 and processing circuitry 1720, and is configured to condition signals communicated between antenna 1711 and processing circuitry 1720. Radio front end circuitry 1712 may be coupled to or a part of antenna 1711. In some embodiments, WD 1710 may not include separate radio front end circuitry 1712; rather, processing circuitry 1720 may comprise radio front end circuitry and may be connected to antenna 1711. Similarly, in some embodiments, some or all of RF transceiver circuitry 1722 may be considered a part of interface 1714. Radio front end circuitry 1712 may receive digital data that is to be sent out to other network nodes or WDs via a wireless connection. Radio front end circuitry 1712 may convert the digital data into a radio signal having the appropriate channel and bandwidth parameters using a combination of filters 1718 and/or amplifiers 1716. The radio signal may then be transmitted via antenna 1711. Similarly, when receiving data, antenna 1711 may collect radio signals which are then converted into digital data by radio front end circuitry 1712. The digital data may be passed to processing circuitry 1720. In other embodiments, the interface may comprise different components and/or different combinations of components.

Processing circuitry 1720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1710 components, such as device readable medium 1730, WD 1710 functionality. Such functionality may include providing any of the various wireless features or benefits discussed herein. For example, processing circuitry 1720 may execute instructions stored in device readable medium 1730 or in memory within processing circuitry 1720 to provide the functionality disclosed herein.

As illustrated, processing circuitry 1720 includes one or more of RF transceiver circuitry 1722, baseband processing circuitry 1724, and application processing circuitry 1726. In other embodiments, the processing circuitry may comprise different components and/or different combinations of components. In certain embodiments processing circuitry 1720 of WD 1710 may comprise a SOC. In some embodiments, RF transceiver circuitry 1722, baseband processing circuitry 1724, and application processing circuitry 1726 may be on separate chips or sets of chips. In alternative embodiments, part or all of baseband processing circuitry 1724 and application processing circuitry 1726 may be combined into one chip or set of chips, and RF transceiver circuitry 1722 may be on a separate chip or set of chips. In still alternative embodiments, part or all of RF transceiver circuitry 1722 and baseband processing circuitry 1724 may be on the same chip or set of chips, and application processing circuitry 1726 may be on a separate chip or set of chips. In yet other alternative embodiments, part or all of RF transceiver circuitry 1722, baseband processing circuitry 1724, and application processing circuitry 1726 may be combined in the same chip or set of chips. In some embodiments, RF transceiver circuitry 1722 may be a part of interface 1714. RF transceiver circuitry 1722 may condition RF signals for processing circuitry 1720.

In certain embodiments, some or all of the functionality described herein as being performed by a WD may be provided by processing circuitry 1720 executing instructions stored on device readable medium 1730, which in certain embodiments may be a computer-readable storage medium. In alternative embodiments, some or all of the functionality may be provided by processing circuitry 1720 without executing instructions stored on a separate or discrete device readable storage medium, such as in a hard-wired manner. In any of those particular embodiments, whether executing instructions stored on a device readable storage medium or not, processing circuitry 1720 can be configured to perform the described functionality. The benefits provided by such functionality are not limited to processing circuitry 1720 alone or to other components of WD 1710, but are enjoyed by WD 1710 as a whole, and/or by end users and the wireless network generally.

Processing circuitry 1720 may be configured to perform any determining, calculating, or similar operations (e.g., certain obtaining operations) described herein as being performed by a WD. These operations, as performed by processing circuitry 1720, may include processing information obtained by processing circuitry 1720 by, for example, converting the obtained information into other information, comparing the obtained information or converted information to information stored by WD 1710, and/or performing one or more operations based on the obtained information or converted information, and as a result of said processing making a determination.

Device readable medium 1730 may be operable to store a computer program, software, an application including one or more of logic, rules, code, tables, etc. and/or other instructions capable of being executed by processing circuitry 1720. Device readable medium 1730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1720. In some embodiments, processing circuitry 1720 and device readable medium 1730 may be considered to be integrated.

User interface equipment 1732 may provide components that allow for a human user to interact with WD 1710. Such interaction may be of many forms, such as visual, audial, tactile, etc. User interface equipment 1732 may be operable to produce output to the user and to allow the user to provide input to WD 1710. The type of interaction may vary depending on the type of user interface equipment 1732 installed in WD 1710. For example, if WD 1710 is a smart phone, the interaction may be via a touch screen; ifWD 1710 is a smart meter, the interaction may be through a screen that provides usage (e.g., the number of gallons used) or a speaker that provides an audible alert (e.g., if smoke is detected). User interface equipment 1732 may include input interfaces, devices and circuits, and output interfaces, devices and circuits. User interface equipment 1732 is configured to allow input of information into WD 1710 and is connected to processing circuitry 1720 to allow processing circuitry 1720 to process the input information. User interface equipment 1732 may include, for example, a microphone, a proximity or other sensor, keys/buttons, a touch display, one or more cameras, a USB port, or other input circuitry. User interface equipment 1732 is also configured to allow output of information from WD 1710, and to allow processing circuitry 1720 to output information from WD 1710. User interface equipment 1732 may include, for example, a speaker, a display, vibrating circuitry, a USB port, a headphone interface, or other output circuitry. Using one or more input and output interfaces, devices, and circuits, of user interface equipment 1732, WD 1710 may communicate with end users and/or the wireless network and allow them to benefit from the functionality described herein.

Auxiliary equipment 1734 is operable to provide more specific functionality which may not be generally performed by WDs. This may comprise specialized sensors for doing measurements for various purposes, interfaces for additional types of communication such as wired communications etc. The inclusion and type of components of auxiliary equipment 1734 may vary depending on the embodiment and/or scenario.

Power source 1736 may, in some embodiments, be in the form of a battery or battery pack. Other types of power sources, such as an external power source (e.g., an electricity outlet), photovoltaic devices or power cells, may also be used. WD 1710 may further comprise power circuitry 1737 for delivering power from power source 1736 to the various parts of WD 1710 which need power from power source 1736 to carry out any functionality described or indicated herein. Power circuitry 1737 may in certain embodiments comprise power management circuitry. Power circuitry 1737 may additionally or alternatively be operable to receive power from an external power source; in which case WD 1710 may be connectable to the external power source (such as an electricity outlet) via input circuitry or an interface such as an electrical power cable. Power circuitry 1737 may also in certain embodiments be operable to deliver power from an external power source to power source 1736. This may be, for example, for the charging of power source 1736. Power circuitry 1737 may perform any formatting, converting, or other modification to the power from power source 1736 to make the power suitable for the respective components of WD 1710 to which power is supplied.

FIG. 18 illustrates a user Equipment in accordance with some embodiments.

FIG. 18 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 18200 may be any UE identified by the 3rd Generation Partnership Project (3GPP), including a NB-IoT UE, a machine type communication (MTC) UE, and/or an enhanced MTC (eMTC) UE. UE 1800, as illustrated in FIG. 18, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 18 is a UE, the components discussed herein are equally applicable to a WD, and vice-versa.

In FIG. 18, UE 1800 includes processing circuitry 1801 that is operatively coupled to input/output interface 1805, radio frequency (RF) interface 1809, network connection interface 1811, memory 1815 including random access memory (RAM) 1817, read-only memory (ROM) 1819, and storage medium 1821 or the like, communication subsystem 1831, power source 1813, and/or any other component, or any combination thereof. Storage medium 1821 includes operating system 1823, application program 1825, and data 1827. In other embodiments, storage medium 1821 may include other similar types of information. Certain UEs may utilize all of the components shown in FIG. 18, or only a subset of the components. The level of integration between the components may vary from one UE to another UE. Further, certain UEs may contain multiple instances of a component, such as multiple processors, memories, transceivers, transmitters, receivers, etc.

In FIG. 18, processing circuitry 1801 may be configured to process computer instructions and data. Processing circuitry 1801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1801 may include two central processing units (CPUs). Data may be information in a form suitable for use by a computer.

In the depicted embodiment, input/output interface 1805 may be configured to provide a communication interface to an input device, output device, or input and output device. UE 1800 may be configured to use an output device via input/output interface 1805. An output device may use the same type of interface port as an input device. For example, a USB port may be used to provide input to and output from UE 1800. The output device may be a speaker, a sound card, a video card, a display, a monitor, a printer, an actuator, an emitter, a smartcard, another output device, or any combination thereof. UE 1800 may be configured to use an input device via input/output interface 1805 to allow a user to capture information into UE 1800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 18, RF interface 1809 may be configured to provide a communication interface to RF components such as a transmitter, a receiver, and an antenna. Network connection interface 1811 may be configured to provide a communication interface to network 1843A. Network 1843A may encompass wired and/or wireless networks such as a local-area network (LAN), a wide-area network (WAN), a computer network, a wireless network, a telecommunications network, another like network or any combination thereof. For example, network 1843A may comprise a Wi-Fi network. Network connection interface 1811 may be configured to include a receiver and a transmitter interface used to communicate with one or more other devices over a communication network according to one or more communication protocols, such as Ethernet, TCP/IP, SONET, ATM, or the like. Network connection interface 1811 may implement receiver and transmitter functionality appropriate to the communication network links (e.g., optical, electrical, and the like). The transmitter and receiver functions may share circuit components, software or firmware, or alternatively may be implemented separately.

RAM 1817 may be configured to interface via bus 1802 to processing circuitry 1801 to provide storage or caching of data or computer instructions during the execution of software programs such as the operating system, application programs, and device drivers. ROM 1819 may be configured to provide computer instructions or data to processing circuitry 1801. For example, ROM 1819 may be configured to store invariant low-level system code or data for basic system functions such as basic input and output (I/O), startup, or reception of keystrokes from a keyboard that are stored in a non-volatile memory. Storage medium 1821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1821 may be configured to include operating system 1823, application program 1825 such as a web browser application, a widget or gadget engine or another application, and data file 1827. Storage medium 1821 may store, for use by UE 1800, any of a variety of various operating systems or combinations of operating systems.

Storage medium 1821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof Storage medium 1821 may allow UE 1800 to access computer-executable instructions, application programs or the like, stored on transitory or non-transitory memory media, to off-load data, or to upload data. An article of manufacture, such as one utilizing a communication system may be tangibly embodied in storage medium 1821, which may comprise a device readable medium.

In FIG. 18, processing circuitry 1801 may be configured to communicate with network 1843B using communication subsystem 1831. Network 1843A and network 1843B may be the same network or networks or different network or networks. Communication subsystem 1831 may be configured to include one or more transceivers used to communicate with network 1843B. For example, communication subsystem 1831 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1833 and/or receiver 1835 to implement transmitter or receiver functionality, respectively, appropriate to the RAN links (e.g., frequency allocations and the like). Further, transmitter 1833 and receiver 1835 of each transceiver may share circuit components, software or firmware, or alternatively may be implemented separately.

In the illustrated embodiment, the communication functions of communication subsystem 1831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1831 may include cellular communication, Wi-Fi communication, Bluetooth communication, and GPS communication. Network 1843B may encompass wired and/or wireless networks such as a local-area network (LAN), a wide-area network (WAN), a computer network, a wireless network, a telecommunications network, another like network or any combination thereof. For example, network 1843B may be a cellular network, a Wi-Fi network, and/or a near-field network. Power source 1813 may be configured to provide alternating current (AC) or direct current (DC) power to components of UE 1800.

The features, benefits and/or functions described herein may be implemented in one of the components of UE 1800 or partitioned across multiple components of UE 1800. Further, the features, benefits, and/or functions described herein may be implemented in any combination of hardware, software or firmware. In one example, communication subsystem 1831 may be configured to include any of the components described herein. Further, processing circuitry 1801 may be configured to communicate with any of such components over bus 1802. In another example, any of such components may be represented by program instructions stored in memory that when executed by processing circuitry 1801 perform the corresponding functions described herein. In another example, the functionality of any of such components may be partitioned between processing circuitry 1801 and communication subsystem 1831. In another example, the non-computationally intensive functions of any of such components may be implemented in software or firmware and the computationally intensive functions may be implemented in hardware.

FIG. 19 illustrates a virtualization environment in accordance with some embodiments.

FIG. 19 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 19, hardware 4330 may be a standalone network node with generic or specific components. Hardware 4330 may comprise antenna 43225 and may implement some functions via virtualization. Alternatively, hardware 4330 may be part of a larger cluster of hardware (e.g., such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 19.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

FIG. 20 illustrates a telecommunication network connected via an intermediate network to a host computer in accordance with some embodiments.

With reference to FIG. 20, in accordance with an embodiment, a communication system includes telecommunication network 2010, such as a 3GPP-type cellular network, which comprises access network 2011, such as a radio access network, and core network 2014. Access network 2011 comprises a plurality of base stations 2012A, 2012B, 2012C, such as NBs, eNBs, gNBs or other types of wireless access points, each defining a corresponding coverage area 2013A, 2013B, 2013C. Each base station 2012A, 2012B, 2012C is connectable to core network 2014 over a wired or wireless connection 2015. A first UE 2091 located in coverage area 2013C is configured to wirelessly connect to, or be paged by, the corresponding base station 2012C. A second UE 2092 in coverage area 2013A is wirelessly connectable to the corresponding base station 2012A. While a plurality of UEs 2091, 2092 are illustrated in this example, the disclosed embodiments are equally applicable to a situation where a sole UE is in the coverage area or where a sole UE is connecting to the corresponding base station 2012.

Telecommunication network 2010 is itself connected to host computer 2030, which may be embodied in the hardware and/or software of a standalone server, a cloud-implemented server, a distributed server or as processing resources in a server farm. Host computer 2030 may be under the ownership or control of a service provider, or may be operated by the service provider or on behalf of the service provider. Connections 2021 and 2022 between telecommunication network 2010 and host computer 2030 may extend directly from core network 2014 to host computer 2030 or may go via an optional intermediate network 2020. Intermediate network 2020 may be one of, or a combination of more than one of, a public, private or hosted network; intermediate network 2020, if any, may be a backbone network or the Internet; in particular, intermediate network 2020 may comprise two or more sub-networks (not shown).

The communication system of FIG. 20 as a whole enables connectivity between the connected UEs 2091, 2092 and host computer 2030. The connectivity may be described as an over-the-top (OTT) connection 2050. Host computer 2030 and the connected UEs 2091, 2092 are configured to communicate data and/or signaling via OTT connection 2050, using access network 2011, core network 2014, any intermediate network 2020 and possible further infrastructure (not shown) as intermediaries. OTT connection 2050 may be transparent in the sense that the participating communication devices through which OTT connection 2050 passes are unaware of routing of uplink and downlink communications. For example, base station 2012 may not or need not be informed about the past routing of an incoming downlink communication with data originating from host computer 2030 to be forwarded (e.g., handed over) to a connected UE 2091. Similarly, base station 2012 need not be aware of the future routing of an outgoing uplink communication originating from the UE 2091 towards the host computer 2030.

FIG. 21 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 21. In communication system 2100, host computer 2110 comprises hardware 2115 including communication interface 2116 configured to set up and maintain a wired or wireless connection with an interface of a different communication device of communication system 2100. Host computer 2110 further comprises processing circuitry 2118, which may have storage and/or processing capabilities. In particular, processing circuitry 2118 may comprise one or more programmable processors, application-specific integrated circuits, field programmable gate arrays or combinations of these (not shown) adapted to execute instructions. Host computer 2110 further comprises software 2111, which is stored in or accessible by host computer 2110 and executable by processing circuitry 2118. Software 2111 includes host application 2112. Host application 2112 may be operable to provide a service to a remote user, such as UE 2130 connecting via OTT connection 2150 terminating at UE 2130 and host computer 2110. In providing the service to the remote user, host application 2112 may provide user data which is transmitted using OTT connection 2150.

Communication system 2100 further includes base station 2120 provided in a telecommunication system and comprising hardware 2125 enabling it to communicate with host computer 2110 and with UE 2130. Hardware 2125 may include communication interface 2126 for setting up and maintaining a wired or wireless connection with an interface of a different communication device of communication system 2100, as well as radio interface 2127 for setting up and maintaining at least wireless connection 2170 with UE 2130 located in a coverage area (not shown in FIG. 21) served by base station 2120. Communication interface 2126 may be configured to facilitate connection 2160 to host computer 2110. Connection 2160 may be direct, or it may pass through a core network (not shown in FIG. 21) of the telecommunication system and/or through one or more intermediate networks outside the telecommunication system. In the embodiment shown, hardware 2125 of base station 2120 further includes processing circuitry 2128, which may comprise one or more programmable processors, application-specific integrated circuits, field programmable gate arrays or combinations of these (not shown) adapted to execute instructions. Base station 2120 further has software 2121 stored internally or accessible via an external connection.

Communication system 2100 further includes UE 2130 already referred to. Its hardware 2135 may include radio interface 2137 configured to set up and maintain wireless connection 2170 with a base station serving a coverage area in which UE 2130 is currently located. Hardware 2135 of UE 2130 further includes processing circuitry 2138, which may comprise one or more programmable processors, application-specific integrated circuits, field programmable gate arrays or combinations of these (not shown) adapted to execute instructions. UE 2130 further comprises software 2131, which is stored in or accessible by UE 2130 and executable by processing circuitry 2138. Software 2131 includes client application 2132. Client application 2132 may be operable to provide a service to a human or non-human user via UE 2130, with the support of host computer 2110. In host computer 2110, an executing host application 2112 may communicate with the executing client application 2132 via OTT connection 2150 terminating at UE 2130 and host computer 2110. In providing the service to the user, client application 2132 may receive request data from host application 2112 and provide user data in response to the request data. OTT connection 2150 may transfer both the request data and the user data. Client application 2132 may interact with the user to generate the user data that it provides.

It is noted that host computer 2110, base station 2120 and UE 2130 illustrated in FIG. 21 may be similar or identical to host computer 2030, one of base stations 2012A, 2012B, 2012C and one of UEs 2091, 2092 of FIG. 20, respectively. This is to say, the inner workings of these entities may be as shown in FIG. 21 and independently, the surrounding network topology may be that of FIG. 20.

In FIG. 21, OTT connection 2150 has been drawn abstractly to illustrate the communication between host computer 2110 and UE 2130 via base station 2120, without explicit reference to any intermediary devices and the precise routing of messages via these devices. Network infrastructure may determine the routing, which it may be configured to hide from UE 2130 or from the service provider operating host computer 2110, or both. While OTT connection 2150 is active, the network infrastructure may further take decisions by which it dynamically changes the routing (e.g., on the basis of load balancing consideration or reconfiguration of the network).

Wireless connection 2170 between UE 2130 and base station 2120 is in accordance with the teachings of the embodiments described throughout this disclosure. One or more of the various embodiments may improve the performance of OTT services provided to UE 2130 using OTT connection 2150, in which wireless connection 2170 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 2150 between host computer 2110 and UE 2130, in response to variations in the measurement results. The measurement procedure and/or the network functionality for reconfiguring OTT connection 2150 may be implemented in software 2111 and hardware 2115 of host computer 2110 or in software 2131 and hardware 2135 of UE 2130, or both. In embodiments, sensors (not shown) may be deployed in or in association with communication devices through which OTT connection 2150 passes; the sensors may participate in the measurement procedure by supplying values of the monitored quantities exemplified above, or supplying values of other physical quantities from which software 2111, 2131 may compute or estimate the monitored quantities. The reconfiguring of OTT connection 2150 may include message format, retransmission settings, preferred routing etc.; the reconfiguring need not affect base station 2120, and it may be unknown or imperceptible to base station 2120. Such procedures and functionalities may be known and practiced in the art. In certain embodiments, measurements may involve proprietary UE signaling facilitating host computer 2110's measurements of throughput, propagation times, latency and the like. The measurements may be implemented in that software 2111 and 2131 causes messages to be transmitted, in particular empty or ‘dummy’ messages, using OTT connection 2150 while it monitors propagation times, errors etc.

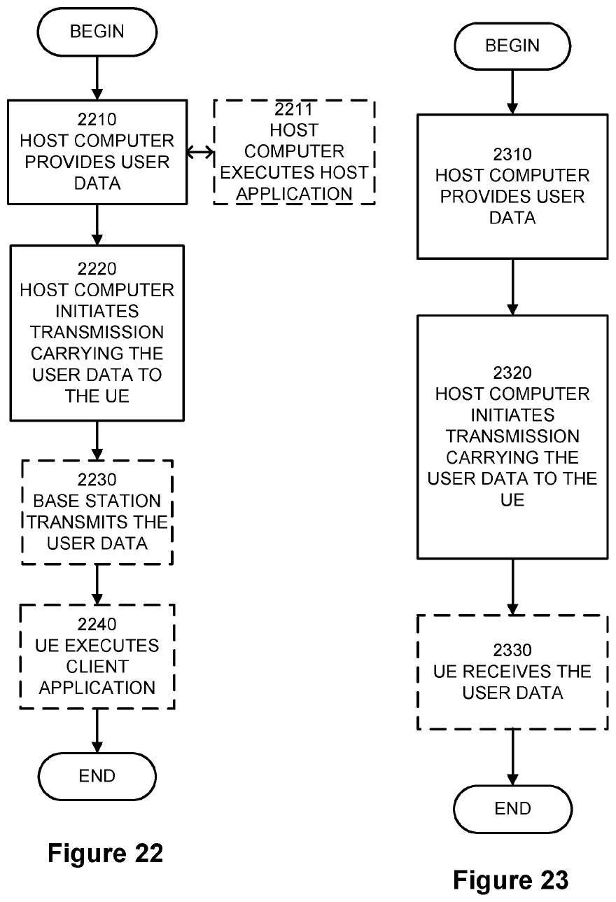

FIG. 22 illustrates methods implemented in a communication system including a host computer, a base station and a user equipment in accordance with some embodiments.

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In step 2210, the host computer provides user data. In substep 2211 (which may be optional) of step 2210, the host computer provides the user data by executing a host application. In step 2220, the host computer initiates a transmission carrying the user data to the UE. In step 2230 (which may be optional), the base station transmits to the UE the user data which was carried in the transmission that the host computer initiated, in accordance with the teachings of the embodiments described throughout this disclosure. In step 2240 (which may also be optional), the UE executes a client application associated with the host application executed by the host computer.

FIG. 23 illustrates methods implemented in a communication system including a host computer, a base station and a user equipment in accordance with some embodiments.

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In step 2310 of the method, the host computer provides user data. In an optional substep (not shown) the host computer provides the user data by executing a host application. In step 2320, the host computer initiates a transmission carrying the user data to the UE. The transmission may pass via the base station, in accordance with the teachings of the embodiments described throughout this disclosure. In step 2330 (which may be optional), the UE receives the user data carried in the transmission.

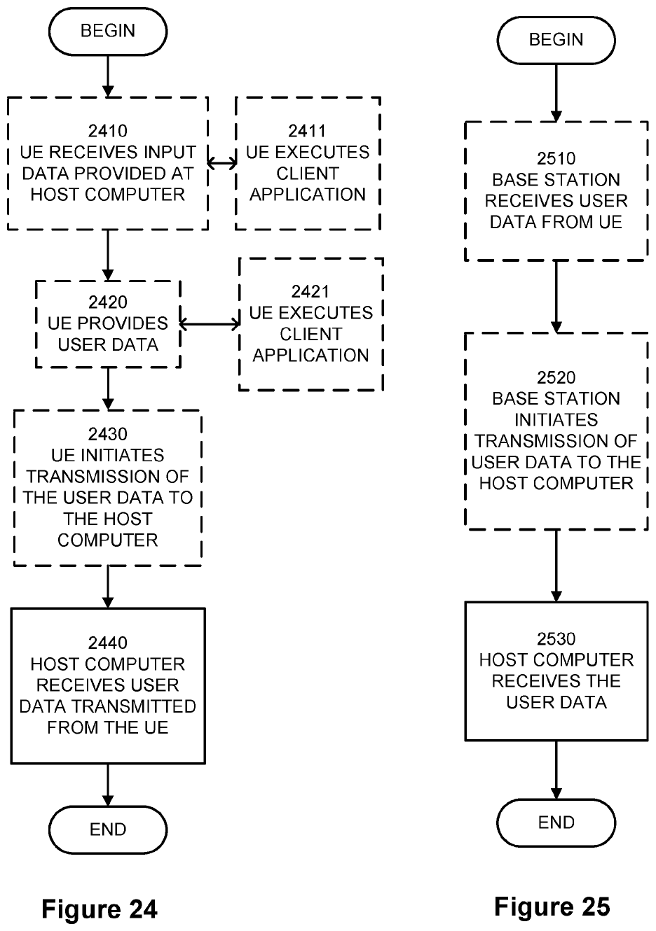

FIG. 24 illustrates methods implemented in a communication system including a host computer, a base station and a user equipment in accordance with some embodiments

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In step 2410 (which may be optional), the UE receives input data provided by the host computer. Additionally or alternatively, in step 2420, the UE provides user data. In substep 2421 (which may be optional) of step 2420, the UE provides the user data by executing a client application. In substep 2411 (which may be optional) of step 2410, the UE executes a client application which provides the user data in reaction to the received input data provided by the host computer. In providing the user data, the executed client application may further consider user input received from the user. Regardless of the specific manner in which the user data was provided, the UE initiates, in substep 2430 (which may be optional), transmission of the user data to the host computer. In step 2200 of the method, the host computer receives the user data transmitted from the UE, in accordance with the teachings of the embodiments described throughout this disclosure.

FIG. 25 illustrates methods implemented in a communication system including a host computer, a base station and a user equipment in accordance with some embodiments

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In step 2510 (which may be optional), in accordance with the teachings of the embodiments described throughout this disclosure, the base station receives user data from the UE. In step 2520 (which may be optional), the base station initiates transmission of the received user data to the host computer. In step 2530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a user equipment, UE, comprising:
obtaining tracking area codes, TACs, broadcast in a cell of a network; and
responsive to none of the broadcast TACs being a last previously selected TAC in the UE, selecting, by a non-access stratum, NAS, layer or an access stratum, AS, layer of the UE one TAC of the broadcast TACs to be a current TAC of the UE.

2. The method of claim 1, further comprising:
responsive to the current TAC not being in a registration area of the UE performing a location update towards the network.

3. The method of claim 1, wherein selecting, by the NAS layer or the AS layer the one TAC comprises:
selecting, by the AS layer, the one TAC of the broadcast TACs; and
reporting the one TAC selected in an update to the NAS layer of the UE.

4. The method of claim 1, wherein selecting the one TAC of the broadcast TACs comprises:
selecting one of the broadcast TACs based on the one of the TACs being present in a registration area of the UE.

5. The method of claim 4, further comprising not performing a location update responsive to one of the broadcast TACs being in the registration area of the UE.

6. The method of claim 1, wherein selecting the one TAC of the broadcast TACs comprises:
responsive to the UE powering on in a cell where more than one TAC is being broadcast, selecting the one TAC from the more than one TAC.

7. The method of claim 1 wherein selecting the one TAC of the broadcast TACs comprises selecting the one TAC based on knowledge about a location of the UE and information about a geographical definition of tracking area borders.

8. The method of claim 1, wherein selecting, by the AS layer, the one TAC of the broadcast TACs comprises selecting the one TAC based on information about how long the network will keep broadcasting respective TACs in the cell.

9. The method of claim 1, wherein in selecting the one TAC, the AS layer favors selection and reporting of a TAC that the AS layer previously reported to the NAS layer since a last time the NAS layer communicated with the network.

10. The method of claim 1, wherein selecting, by the NAS layer or the AS layer the one TAC comprises selecting, by the NAS layer the one TAC of the broadcast TACs.

11. The method of claim 10, wherein selecting, by the NAS layer the one TAC of the broadcast TACs comprises:
receiving, by the NAS layer, a list of the TACs being broadcast to the NAS layer of the UE;
selecting, by the NAS layer of the UE, one TAC in the list of TACs to be considered as a current TAC of the UE; and
providing the AS layer of the UE an indication of the one TAC.

12. The method of claim 11 wherein receiving, by the NAS layer, the list of the TACs comprises receiving the list of TACs responsive to there being a change in the TACs obtained.

13. The method of claim 11 wherein selecting the one TAC comprises selecting the one TAC based on information available to the NAS layer of the UE.

14. The method of claim 13 wherein the information comprises an identification of TACs in the registration area of the UE.

15. The method of claim 13 wherein the information comprises a geographical definition of tracking area borders.

16. The method of claim 11 wherein selecting the one TAC comprises selecting the one TAC to minimize further location updates by the UE.

17. The method of claim 1, further comprising:
transmitting, via radio resource control, RRC, signalling, a current TAC selected towards a network base station.

18. A user equipment, UE comprising:
processing circuitry; and
memory coupled with the processing circuitry, wherein the memory includes instructions that when executed by the processing circuitry causes the communication device to perform operations according to claim 1.

19. A user equipment, UE, adapted to perform according to claim 1.

20. A computer program comprising program code to be executed by processing circuitry of a user equipment, UE, whereby execution of the program code causes the UE to perform operations according to claim 1.

21. A computer program product comprising a non-transitory storage medium including program code to be executed by processing circuitry of a user equipment, UE, whereby execution of the program code causes the user equipment, UE, to perform operations according to claim 1.

22. A method performed by a radio access network, RAN, node in a network, the method comprising:
receiving, from a user equipment, UE, a current tracking area code, TAC, selected by the UE via radio resource control, RRC, signalling; and
determining UE location information based on the TAC received from the UE.

23. The method of claim 22, further comprising:
providing the UE location information including a tracking area identity to an access and mobility management function, AMF, node of the network.

24. A radio access network, RAN, node comprising:
processing circuitry; and
memory coupled with the processing circuitry, wherein the memory includes instructions that when executed by the processing circuitry causes the RAN node to perform operations according to claim 22.

25. A radio access network, RAN, node adapted to perform according to claim 22.

26. A computer program comprising program code to be executed by processing circuitry of a radio access network, RAN, node, whereby execution of the program code causes the RAN node to perform operations according to claim 22.

27. (canceled)
